(19) United States
(12) Patent Application Publication
(10) Pub. No.: US 2024/0335772 A1
(43) Pub. Date: Oct. 10, 2024

(54) FILTER CARTRIDGE WITH EXPANDABLE ENDPLATE SEAL

(71) Applicant: CUMMINS FILTRATION INC., Nashville, TN (US)

(72) Inventors: Manikandan Annamalai, Cookeville, TN (US); Jack Sims, Maryville, TN (US); Carey A. Curt, Cookeville, TN (US); Mark J. Johnson, Cookeville, TN (US); Daniel Potratz, Stoughton, WI (US); Joshua Ryan Hendrixson, Cookeville, TN (US)

(73) Assignee: CUMMINS FILTRATION INC., Nashville, TN (US)

(21) Appl. No.: 18/292,210

(22) PCT Filed: Jul. 27, 2022
(86) PCT No.: PCT/US2022/038544

§ 371 Date: Jan. 25, 2024

Related U.S. Application Data
(60) Provisional application No. 63/226,518, filed on Jul. 28, 2021.

(51) Int. Cl. B01D 29/13; B01D 35/00; F01M 11/03; F02M 37/34

(52) U.S. Cl. CPC B01D 29/13; B01D 35/005; F01M 11/03; F02M 37/34; B01D 2201/0415; B01D 2201/295; B01D 2201/304; B01D 2201/345

(57) ABSTRACT

A fluid filtration system is provided. The system includes a filter head and a filter cartridge removably coupled to the filter head. The filter cartridge includes a shell housing defining a first housing end, a second housing end, and a housing sidewall extending between the first housing end and the second housing end. The filter cartridge further includes a filter element received within the shell housing and removably coupled to the shell housing. The filter element includes a media pack and an endplate. The media pack is configured to filter matter from a fluid flowing therethrough. The endplate is coupled to an end of the media pack. The endplate includes an expansible scaling member extending axially away from the endplate in a direction opposite to the media pack and having a compliant portion. The expansible sealing member is configured to expand in diameter when the expansible sealing member engages the shell housing.

### CROSS-REFERENCE TO RELATED PATENT APPLICATIONS

This application is the U.S. national phase of PCT Application No. PCT/US2022/038544, filed Jul. 27, 2022, which claims priority to and the benefit of U.S. Provisional Patent Application No. 63/226,518, filed on Jul. 28, 2021, the content of which is hereby incorporated by reference in its entirety.

### TECHNICAL FIELD

The present application relates generally to fluid filtration systems for internal combustion engines.

### BACKGROUND

In various applications, it is generally desirable to minimize an amount of particulate contamination in liquids used to power and lubricate an internal combustion engine. The amount of particulate contamination can be reduced by passing the liquids through a filter element or cartridge, which captures solid particles entrained within the fluid. The structure of the cartridge and the materials used in the construction of the cartridge may have a fixed orientation relative to the system that the cartridge is used with, such as a filter head. Because misalignment may prevent operation of the system or damage the system, cartridges are carefully controlled by an original equipment manufacturer (OEM) in order to prevent damage to the engine and to ensure optimal engine performance.

### SUMMARY

At least one embodiment relates to a fluid filtration system. The system includes a filter head and a filter cartridge removably coupled to the filter head. The filter cartridge includes a shell housing defining a first housing end, a second housing end, and a housing sidewall extending between the first housing end and the second housing end. The filter cartridge further includes a filter element received within the shell housing and removably coupled to the shell housing. The filter element includes a media pack and endplate. The media pack is configured to filter matter from a fluid flowing therethrough. The endplate is coupled to an end of the media pack. The endplate includes an expansible sealing member extending axially away from the endplate in a direction opposite to the media pack and having a compliant portion. The expansible sealing member is configured to expand in diameter when the expansible sealing member engages the shell housing.

At least one embodiment relates to a filter cartridge. The filter cartridge includes a generally cylindrical shell housing defining a central axis. The shell housing includes a first housing end. The shell housing includes a second housing end opposite to the first housing end. The shell housing includes a housing sidewall extending between the first housing end and the second housing end. The housing sidewall includes an inner housing surface and an outer housing surface. The shell housing includes a first groove wall and a second groove wall extending axially away from the second housing end in a direction toward the first housing end. The first groove wall and the second groove wall extend to a first height. The first groove wall and the second groove wall cooperate to define a housing groove therebetween. The filter cartridge includes a filter element received within and removably coupled to the shell housing. The filter element includes an endplate including an annular sealing member extending axially away from the endplate and configured to extend into the housing groove.

At least one embodiment relates to an endplate of a fluid filtration system. The endplate includes a first sidewall defining at least a part of an outlet aperture. The endplate includes a second sidewall disposed apart from the first sidewall. The endplate includes a bottom surface extending between the first sidewall and the second sidewall. The endplate includes a coupling aperture extending through the endplate. The coupling aperture is used to receive a portion of a sealing member.

This summary is illustrative only and should not be regarded as limiting.

### BRIEF DESCRIPTION OF THE FIGURES

The disclosure will become more fully understood from the following detailed description, taken in conjunction with the accompanying figures, wherein like reference numerals refer to like elements, in which:

FIG. 1 is a cross-sectional view of a liquid filtration system, according to an example embodiment;

FIG. 2 is an exploded cross-sectional view of a lower portion of a filter element and a shell housing of the liquid filtration system of FIG. 1;

FIG. 3 is a detailed cross-sectional view of a portion of the shell housing and the filter element of FIG. 2;

FIG. 4 is a cross-sectional view of the lower portion of the liquid filtration system of FIG. 2 with the filter element coupled to the shell housing;

FIG. 5A is a detailed cross-sectional view of a portion of the shell housing and the filter element of FIG. 4;

FIG. 5B is a detailed cross-sectional view of a portion of the shell housing and the filter element of FIG. 4;

FIG. 5C is a detailed cross-sectional view of a portion of the shell housing and the filter element of FIG. 4;

FIG. 6 is a cross-sectional view of a filter element of the liquid filtration system of FIG. 1, according to another example embodiment;

FIG. 7 is a cross-sectional view of a lower portion of a liquid filtration system having a filter element coupled to a shell housing, according to another example embodiment;

FIG. 8 is a top view of an endplate of the filter element of FIG. 7;

FIG. 9 is a cross-sectional view of the endplate of FIG. 8;

FIG. 10 is a perspective view of the lower portion of the shell housing of FIG. 1;

FIG. 11 is a detailed cross-sectional view of the lower portion of the shell housing of FIG. 1, according to an example embodiment;

FIG. 12 is a detailed cross-sectional view of a portion of the shell housing of FIG. 11;

FIG. 13 is a perspective view of the lower portion of the shell housing of FIG. 11; and

FIG. 14 is a perspective view of an alternative example lower portion of a shell housing.

FIG. 15 is a top view of an endplate for a liquid filtration system, according to an example embodiment.

FIG. 16 is a bottom view of the endplate of FIG. 15.

FIG. 17 is a perspective view of the endplate of FIG. 15 and a sealing member, according to an example embodiment.

FIG. 18 is a cross-sectional view of the endplate and sealing member of FIG. 17.

FIG. 19 is a top view of an endplate for a liquid filtration system, according to an example embodiment.

FIG. 20 is a bottom view of the endplate of FIG. 19.

FIG. 21 is a perspective view of the endplate of FIG. 19 and to a sealing member, according to an example embodiment.

FIG. 22 is a cross-sectional view of the endplate and sealing member of FIG. 21.

FIG. 23 is a perspective view of the lower end of the shell housing, according to an example embodiment.

FIG. 24 is a detailed view of the lower end of the shell housing of FIG. 23, according to an example embodiment.

FIG. 25 is a detailed view of the lower end of the shell housing of FIG. 23, according to an example embodiment.

FIG. 26 is a perspective view of the lower end of the shell housing of FIG. 23, according to an example embodiment.

FIG. 27 is a detailed view of the lower end of the shell housing of FIG. 26, according to an example embodiment.

FIG. 28 is a perspective view of the lower end of the shell housing of FIG. 23, according to an example embodiment.

It will be recognized that some or all of the figures are schematic representations for purposes of illustration. The figures are provided for the purpose of illustrating one or more implementations with the explicit understanding that they will not be used to limit the scope or the meaning of the claims.

### DETAILED DESCRIPTION

Following below are more detailed descriptions of various concepts related to, and implementations of, methods, apparatuses, and systems for sealing and retaining a filter element within a shell housing. The various concepts introduced above and discussed in greater detail below may be implemented in any of numerous ways, as the described concepts are not limited to any particular manner of implementation. Examples of specific implementations and applications are provided primarily for illustrative purposes.

Before turning to the figures, which illustrate certain exemplary embodiments in detail, it should be understood that the present disclosure is not limited to the details or methodology set forth in the description or illustrated in the figures. It should also be understood that the terminology used herein is for the purpose of description only and should not be regarded as limiting.

### I. Overview

Internal combustion engine systems require a clean source of fuel to power the engine. Unfiltered fuel may include dirt, metal particles, and other solid contaminants that can damage fuel injectors and other engine components. In order to protect the injectors, many internal combustion engine systems include fuel filtration systems, which filter the fuel to remove any solid materials before passing the fuel to the injectors. The filtration system may include a filter cartridge and a filter head. In operation, the filtration system directs the fuel through the filter cartridge, which includes a filter element that captures any solid particulate entrained in the fuel. The performance of the filtration system depends, among other factors, on the structure of the filter cartridge and the materials used to construct the filter cartridge (e.g., the materials used to produce a filter element for the filter cartridge, the specifications of the filter element and the media pack such as the flow area of the media pack, the pleat depth of the media pack, and other factors).

Over time, accumulated particulate on the filter cartridge (e.g., carbon, dust, metal particles, etc.) can increase the pressure drop across the filter cartridge (and, correspondingly, a pressure drop across a fuel delivery system for the engine). In order to reduce the pressure drop, the filter cartridge can be removed from the filtration system and replaced with a clean filter cartridge. In some embodiments, the filter element of the filter cartridge may be removed and replaced with a new filter element.

Implementations herein relate to methods and systems of sealing a filter element in a shell housing to facilitate a unique sealing interface between a filter cartridge and a filter head. The sealing member is flexible and expansible and extends into a groove of the shell housing. The sealing member defines a length that is greater than a depth of the groove. Thus, the sealing member engages a bottom of the groove before the filter element is fully set into the shell housing. When the filter cartridge is fully set, the sealing member expands to engage both sides of the cavity to form a sealing engagement with the surfaces of the groove. In some embodiments, the sealing member includes a bellows member that facilitates radial expansion of the sealing member and engagement of the sealing member with the groove walls. The expansion of the seal member allows for increased leak resistance under increased fluid pressures.

Various features may be added to the shell housing and the groove walls to prevent the use of unauthorized fluid filters in the shell housing. For example, holes that extend through the shell housing may be placed at the bottom of the groove. This may reduce or eliminate the ability of an axial sealing member from forming a fluid sealing engagement with the shell housing. The expansible sealing member may also reduce the machining tolerances required for manufacturing of the shell housing. For example, the groove surfaces may be slightly closer together or slightly further apart than designed without affecting the effectiveness of the sealing engagement between the expansible sealing member and the shell housing.

### II. Example Fluid Filtration System

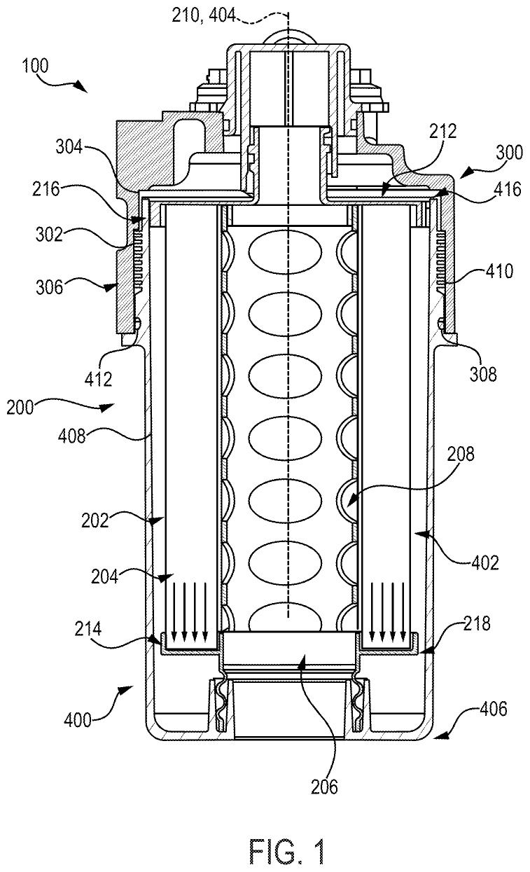

FIG. 1 is a cross-sectional view of a first example liquid filtration system, shown as system 100. The system 100 may be used to filter a fluid provided to an internal combustion engine. The fluid may be a fuel, an engine oil, a hydraulic oil, or another lubricant. In the example embodiment of FIG. 1, the system 100 is a fuel filtration system for a diesel engine that uses diesel fuel to drive the combustion process. The system 100 is configured to be mounted on the diesel engine. In other embodiments, the system 100 may be configured to be mounted remotely from the engine (e.g., on a vehicle chassis, etc.). Although a liquid filtration system is discussed in detail herein, the filtration system and related components may also be used in other fluid filtration arrangements such as an air filtration system. Therefore, the disclosure provided herein is equally applicable to filtration of fluids other than liquids (e.g., air).

As shown in FIG. 1, the system 100 includes a filter cartridge 200 and a filter head 300. The filter cartridge 200 (e.g., filter cartridge assembly, cartridge assembly, etc.) is removably coupled to the filter head 300 to allow for the filter cartridge 200 to be serviced or replaced. In some embodiments, the filter cartridge 200 is threadably coupled to the filter head 300. The filter cartridge 200 includes a filter element 202 and a shell housing 400. In some embodiments, the filter element 202 and the shell housing 400 are coupled together, for example by fasteners or adhesives, such that separation of the filter element 202 and the shell housing 400 cannot be separated without a physical destruction of one or more components. In other embodiments, the filter element 202 is removably coupled to the shell housing 400 such that the filter element 202 may be removed from the shell housing 400 and replaced with a new filter element.

The filter element 202 is disposed within a hollow portion 402 of the shell housing 400 such that a central axis 404 of the shell housing 400 extends through the filter element 202. The filter element 202 may be cylindrically-shaped and may include a cylindrically-shaped media pack 204. The media pack 204 includes filter media configured to filter particulate matter from a fluid flowing therethrough so as to produce filtered fluid (e.g., clean fluid). The filter media may include a porous material having a predetermined pore size. The filter media may include a paper-based filter media, a fiber-based filter media, a foam-based filter media, or the like. The filter media may be pleated or formed into another desired shape to increase a flow area through the media pack 204, or to otherwise alter the particle removal efficiency of the filter element 202. The filter element 202 may be arranged as an outside-in flow filter element having an outer dirty side and an inner clean side. In an alternative arrangement, the filter element 202 is an inside-out filter element having an inner dirty side and an outer clean side. Fluid to be filtered passes from the dirty side of the filter element 202 to the clean side of the filter element 202.

The filter element 202 defines a central opening 206 extending along a central axis 210 (e.g., a longitudinal axis, up and down as shown in FIG. 1) of the filter element 202. In some embodiments, the filter element 202 is positioned within the shell housing 400 such that the central axis 210 of the filter element 202 is coaxial (e.g., coincident) with the central axis 404 of the shell housing 400. A center support tube 208 is positioned within the media pack 204 and extends longitudinally along at least a portion of the central opening 206 from a first, upper end 212 of the filter element 202 to a second, bottom end 214 of the filter element 202. The media pack 204, and thus the support tube 208, is concentric with the filter element 202 and the shell housing 400. In other words, a central axis of the media pack 204 is coaxial or substantially coaxial with the central axis 210 of the filter element 202 as a whole and the central axis 404 of the shell housing 400. As shown in FIG. 1, the support tube 208 is formed in the shape of a hollow cylinder. An outer wall of the support tube 208 is perforated in order to allow fluid to pass through the support tube 208.

The shell housing 400 defines a hollow portion 402 having an inner cross-sectional diameter within which the filter element 202 is positioned. The shell housing 400 (e.g., a filter housing, container, or reservoir) includes an upper (e.g., first) end 416, a lower (e.g., second) end 406, and a sidewall 408 extending between the upper end 416 and the lower end 406 in a substantially concentric orientation relative to the central axis 404. The shell housing 400 may be formed from a strong and rigid material. For example, the shell housing 400 may be formed from a plastic material (e.g., polypropylene, high density polyethylene, polyvinyl chloride, nylon, etc.), a metal (e.g., aluminum, stainless steel, etc.), or another suitable material. The cross-sectional shape of the shell housing 400 may be the same or similar to the cross-sectional shape of the filter element 202. As shown in FIG. 1, the shell housing 400 is formed in the shape of a cylinder such that the shell housing 400 has a generally circular cross-section normal to the central axis 404 of the shell housing 400. In other embodiments, the shell housing 400 and/or the filter element 202 may have any other suitable cross-sectional shape; for example, racetrack/obround, oval, rounded rectangular, or another suitable shape.

As shown in FIG. 1, the shell housing 400 is threadably coupled to the filter head 300. The shell housing 400 includes a male threaded portion 410 disposed on the sidewall 408 of the shell housing 400 and extending downwardly (e.g., parallel to the central axis 404 of the shell housing 400) from a first, upper end 416 of the shell housing 400. The male threaded portion 410 is engaged with a female threaded portion 302 of the filter head 300. As shown in FIG. 1, the female threaded portion 302 is disposed on an inner surface 304 of an outer flange 306 of the filter head 300 such that, in an installed position (as shown in FIG. 1), the outer flange 306 at least partially surrounds the shell housing 400. The shell housing 400 and/or the filter head 300 may include one or more sealing mechanisms to prevent fluid from leaking into an environment surrounding the system 100. As shown in FIG. 1, the shell housing 400 includes a radial sealing member 412 (e.g., an O-ring, etc.) that presses against the inner surface 304 of the outer flange 306 proximate to a lower edge 308 of the outer flange 306.

The filter element 202 is structured to detachably (e.g., removably) couple to the shell housing 400 and the filter head 300. The filter element 202 includes a first endplate 216 coupled to the first end 212 of the filter element 202 and a second endplate 218 coupled to the second end 214 of the filter element 202. The first endplate 216 and the second endplate 218 may be coupled to the media pack 204 using glue or another suitable bonding agent (e.g., adhesive product) in order to seal the first end 212 and the second end 214 of the media pack 204 and to prevent dirty fluid from bypassing the filter media through the first end 212 and the second end 214. In some embodiments, the first endplate 216 and the second endplate 218 are coupled to the media pack 204 without the use of adhesives. For example, a portion of the first endplate 216 may be heated to a molten state. The media pack 204 may then be plunged into the molten portion of the first endplate 216 to seal the media pack 204 to the first endplate 216. Similarly, a portion of the second endplate 218 may be heated to a molten state. The media pack 204 may then be plunged into the molten portion of the second endplate 218 to seal the media pack 204 to the second endplate 218. Coupling the first endplate 216 and the second endplate 218 in this way may reduce or eliminate the need for using adhesives, potting, or similar compounds to couple the media pack 204 to the first endplate 216 and the second endplate 218.

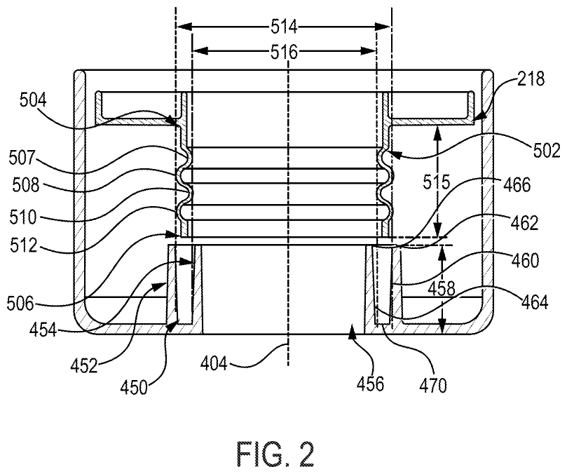

FIG. 2 shows a cross-sectional view of the second endplate 218 of the filter element 202. The second endplate 218 includes a first sealing member 502 (e.g., expansible sealing member, expandable sealing member, bellowed sealing member, etc.) extending axially away from the second endplate 218 in a direction opposite to the media pack 204. The first sealing member 502 is configured to extend into a housing groove 450 (e.g., concentric groove, annular groove, etc.) that extends concentrically about the central axis 404. The first sealing member 502 defines a first seal end 504 coupled to the second endplate 218 and a second seal end 506 positioned opposite to the first seal end 504. A height of the first sealing member 502, shown as a seal height 515, is defined as a distance between the first seal end 504 and the second seal end 506. In some embodiments, the seal height 515 may be approximately 17 mm (+/−0.5 mm), although other heights are possible. Although the first sealing member 502 is mainly discussed herein with respect to the second endplate 218, the first endplate 216 may also be configured to include the first sealing member 502 and any other sealing members discussed herein. Therefore, the disclosure provided herein regarding the second endplate 218 is equally applicable to the first endplate 216.

The shell housing 400 includes a housing groove 450 cooperatively defined by a first groove wall 452 and a second groove wall 454. The first groove wall 452 and the second groove wall 454 are concentric about the central axis 404 and extend axially away from the lower end 406 of the shell housing 400 in a direction toward the upper end 416 of the shell housing 400. The first groove wall 452 and the second groove wall 454 extend away from the lower end 406 a distance shown as a wall height 458. Both the first groove wall 452 and the second groove wall 454 define the same wall height 458. In some embodiments, the first groove wall 452 defines a wall height greater than or less than the wall height of the second groove wall 454. The wall height 458 is less than the seal height 515. In some embodiments, the wall height 458 may be less than half of the seal height 515. For example, the wall height 458 may be approximately 7.28 mm (+/−0.5 mm).

The first groove wall 452 includes a first groove surface 460 extending from the lower end 406 to an end 462 of the first groove wall 452. The first groove surface 460 is the radially inward facing surface of the first groove wall 452. The first groove surface 460 may be smooth and continuously extend circumferentially about the first groove wall 452 concentrically about the central axis 404. The first groove surface 460 may be vertical such that a diameter of the first groove surface 460 remains unchanged between the lower end 406 and the end 462. In some embodiments, the first groove surface 460 is slightly tapered toward the lower end 406 such that a diameter of the first groove surface 460 is smaller proximate to the lower end 406 then than proximate the end 462.

The second groove wall 454 includes a second groove surface 464 extending from the lower end 406 to an end 466 of the second groove wall 454. The second groove surface 464 is the radially outward-facing surface of the second groove wall 454. The second groove surface 464 may be smooth and continuously extend circumferentially about the second groove wall 454 concentrically about the central axis 404. The second groove surface 464 may be vertical such that a diameter of the second groove surface 464 remains unchanged between the lower end 406 and the end 466. In some embodiments, the second groove surface 464 is slightly tapered toward the end 466 such that a diameter of the second groove surface 464 is larger proximate to the lower end 406 than proximate the end 466.

A third groove surface 470 is positioned proximate to the lower end 406 and is contiguous with both the first groove surface 460 and the second groove surface 464. In some embodiments, the third groove surface 470 is solid and extends continuously about housing groove 450. As will be discussed in greater detail herein, the third groove surface 470 may include apertures, ridges, bumps, and similar features to prevent an axial sealing engagement from being formed with the third groove surface 470. The third groove surface 470 may also include one or more apertures (e.g., drains) that define a flow path for fluid to exit the liquid filtration system 100.

Extending through a center portion of the lower end 406 of the shell housing 400 is an aperture 456. The aperture 456 is defined, at least in part, by the second groove wall 454.

The first sealing member 502 can define any projected shape relative to the second endplate 218. For example, in some embodiments, the first sealing member 502 defines an annular body. In other embodiments, the first sealing member 502 may define, for example, an oval body. The shape of the first sealing member 502 may match the shape of the filter element 202 or may have a different configuration. The annular body may include a bellows member 511. The bellows member 511 includes alternating inwardly and outwardly curved protrusions shown as a first protrusion 507 (e.g., inward protrusion), a second protrusion 508 (e.g., outward protrusion), a third protrusion 510 (e.g., inward protrusion), and a fourth protrusion 512 (e.g., outward protrusion). The bellows member 511 can include any number of protrusions. The bellows member 511 facilitates both axial and radial expansion of the first sealing member 502 relative to the central axis 404 when the first sealing member 502 is positioned within the housing groove 450. Because the seal height 515 is greater than the wall height 458, the second seal end 506 engages the third groove surface 470 before the second endplate 218 engages the first groove wall 452 and the second groove wall 454 as the first sealing member 502 is extended into the housing groove 450. The filter element 202 is properly set in the shell housing 400 when the second endplate 218 engages the first groove wall 452. Thus, as the second endplate 218 nears the first groove wall 452 and the second groove wall 454, the first sealing member 502 is axially compressed such that the seal height 515 shortens until the seal height 515 is approximately equal to the wall height 458. As the first sealing member 502 is compressed, the bellows member 511 facilitates radial expansion of the first sealing member 502 such that the first sealing member 502 forms a sealing engagement with both the first groove surface 460 and the second groove surface 464. In some implementations, the bellows member 511 creates a spring force when compressed that biases the bellows member 511 to return to its uncompressed (e.g., relaxed) state, as shown in FIG. 2. The spring force facilitates easier removal of the first sealing member 502 from the housing groove 450.

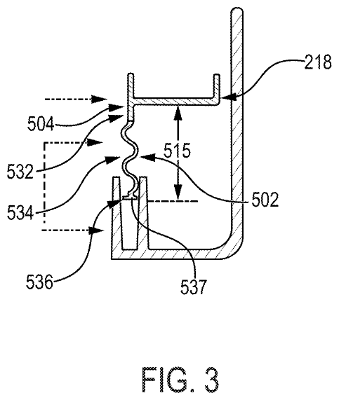

In some embodiments, the first sealing member 502 is formed of multiple portions including portions formed of compliant material (e.g., NBR, fluorosilicon, Viton, Nitrile 70 Duro, etc.) and portions formed of a substantially and comparatively rigid material (e.g., plastic, metal, etc.). As shown in FIG. 3, the first sealing member 502 includes a first rigid portion 532 that extends axially away from the second endplate 218 in a direction away from the media pack 204. The first sealing member 502 further includes a first compliant portion 534 coupled to the first rigid portion 532 and having the bellows member 511. Coupled to the first compliant portion 534 opposite to the first rigid portion 532 is a second rigid portion 536. The second rigid portion 536 may be overmolded with the first compliant portion 534 and may prevent damage to the first compliant portion 534. For example, if the filter element 202 is not inserted concentrically within the shell housing 400 during installation, the second seal end 506 may engage a sharp corner of the first groove wall 452 or the second groove wall 454, which may damage the first sealing member 502, and specifically the first compliant portion 534. The second rigid portion 536 may be coupled to the second seal end 506 to prevent damage to the first compliant portion 534 during rough handling or improper installation.

The first protrusion 507, second protrusion 508, and the fourth protrusion 512 (e.g., the outward protrusions) cooperatively define an outer seal diameter 514 when the first sealing member 502 is in an uncompressed (e.g., relaxed) state, as shown in FIG. 2. The outer seal diameter 514 is less than the diameter of the first groove surface 460 proximate the end 462 of the first groove wall 452. The first protrusion 507 and the third protrusion 510 (e.g., the inner protrusions) cooperatively define an inner seal diameter 516 when the first sealing member 502 is in an uncompressed state. The inner seal diameter 516 is greater than the diameter of the second groove surface 464 proximate to the end 466 of the second groove wall 454. A difference between the inner seal diameter 516 and the outer seal diameter 514 (e.g., a width of the first sealing member 502) is less than a difference between the diameter of the first groove surface 460 and the second groove surface 464 (e.g., a width of the housing groove 450). For example, the difference between the inner seal diameter 516 and the outer seal diameter 514 may be approximately 12.5 mm (+/−0.5 mm) and the difference between the diameter of the first groove surface 460 and the second groove surface 464 may be approximately 13.9 mm (+/−0.5 mm). Therefore, the first sealing member 502 can expand radially within the housing groove 450 to form a sealing engagement with both the first groove surface 460 and the second groove surface 464.

Referring now to FIG. 3, a detailed cross-sectional view of part the first sealing member 502 is shown, according to an example embodiment. A difference between the first sealing member 502 of FIG. 2 and the first sealing member 502 of FIG. 3 is that the second rigid portion 536 of the first sealing member 502 of FIG. 3 defines an annular ring body 537. The annular ring body 537 is sized to rest flush against the third groove surface 470 when the first sealing member 502 is positioned within the housing groove 450. The first sealing member 502 is coupled to the second endplate 218. In some embodiments, the first sealing member 502 may be coupled to the first endplate 216. The first sealing member 502 may be formed of a compliant and flexible material, such as a polymeric material. The first sealing member 502 may be formed of a material different from the second endplate 218 and later coupled to the second endplate 218. For example, the first sealing member 502 may be coupled to the second endplate 218 via a mechanical attachment, a chemical bond, or an adhesive, or via other mechanisms. In some embodiments, the first sealing member 502 is overmolded with the second endplate 218. In some embodiments, the first sealing member 502 and the second endplate 218 are integrally formed with one another. As utilized herein, two or more elements are “integrally formed” with each when the two or more elements are formed and joined together as part of a single manufacturing process to create a single-piece or unitary construction that cannot be disassembled without an at least partial destruction of the overall component.

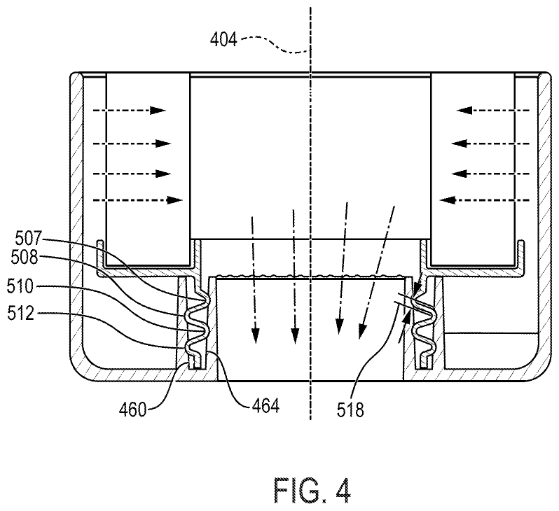

Referring now to FIG. 4, a cross-sectional view of the filter element 202 positioned in the shell housing 400 is shown. Specifically, the lower end 406 of the shell housing 400 and the second endplate 218 are shown. The filter element 202 is moved axially into the shell housing 400 until the second endplate 218 engages the first groove wall 452. The first sealing member 502 expands such that the first protrusion 507 and the third protrusion 510 engage the second groove surface 464 and the second protrusion 508 and the fourth protrusion 512 engage the first groove surface 460. The first sealing member 502 has a radial thickness 518 of approximately 0.75 millimeters. The thickness of the first sealing member 502 is sized such that the first sealing member 502 may expand to fill the housing groove 450 while also being rigid enough to prevent fluid bypass between the first sealing member 502 and the housing groove 450. As shown in FIG. 4, the first sealing member 502 accordions axially such that the first protrusion 507, the second protrusion 508, the third protrusion 510, and the fourth protrusion 512 are evenly spaced axially between the first seal end 504 and the second seal end 506.

When fluid flows through the filter element 202, additional pressure is applied downwardly on the second endplate 218 that compresses the first sealing member 502 into the housing groove 450. Thus, the first sealing member 502 exhibits self-pressurizing behavior that increases the sealing engagement between the first sealing member 502 and the shell housing 400 when fluid flows through the filter element 202.

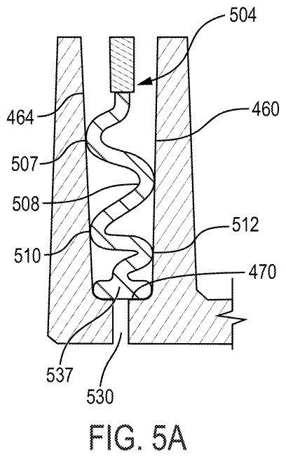

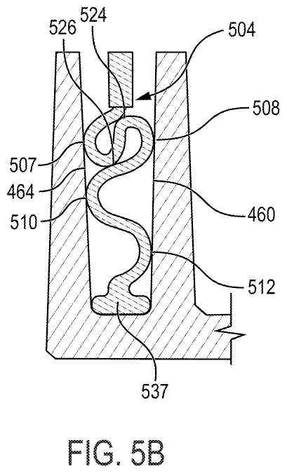

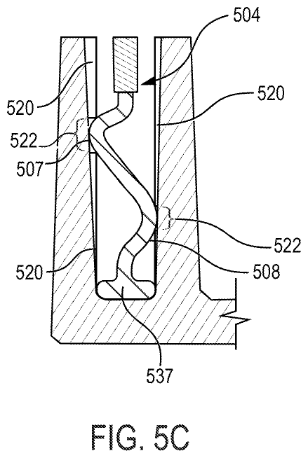

Turning now to FIG. 5A, a detailed cross-sectional view of part of the first sealing member 502 is shown positioned within the housing groove 450 when the second endplate 218 engages the first groove wall 452. In some embodiments, the housing groove 450 includes a housing drain 530. The housing drain 530 extends through the third groove wall 470 of the housing groove 450 such that fluid can exit the liquid filtration system 100 when the first sealing member 502 is not disposed in the housing groove 450. For example, the first sealing member 502 can seal the housing drain 530 when disposed in the housing groove 450. The second seal end 506 can cover the housing drain 530. The first sealing member 502 can prevent fluid from exiting through the housing drain 530. With the first sealing member 502 removed from the housing groove 450, the housing drain 530 is opened and fluid in the shell housing 400 can drain through the housing drain 530. The housing drain 530 can be fluidly coupled to a tank such that the fluid can drain from the shell housing 400 to the tank.

Turning now to FIG. 5B, a detailed cross-sectional view of part of the first sealing member 502 is shown positioned within the housing groove 450 when the second endplate 218 engages the first groove wall 452. The first sealing member 502 is compressed irregularly such that the first protrusion 507, the second protrusion 508, the third protrusion 510, and the fourth protrusion 512 are not evenly spaced axially between the first seal end 504 and the second seal end 506. As shown in FIG. 5B, the first protrusion 507 engages the second groove surface 464 at a similar height to where the second protrusion 508 engages the first groove surface 460. In some embodiments, the first sealing member 502 folds such that portions of the first sealing member 502 sealingly engage other portions of the first sealing member 502. One such engagement is shown as a first self-engagement point 524. Specifically, a portion of the first sealing member 502 positioned between the first seal end 504 and the first protrusion 507 engages a portion of the first sealing member 502 positioned between the first protrusion 507 and the second protrusion 508. Another such engagement is shown as a second self-engagement point 526. Specifically, a portion of the first sealing member 502 positioned between the first protrusion 507 and the second protrusion 508 engages a portion of the first sealing member 502 positioned between the second protrusion 508 and the third protrusion 510. Accordingly, the first sealing member 502 forms redundant sealing engagements. As shown, five such sealing engagements are shown between the first sealing member 502 and the housing groove 450, and two sealing engagements are formed between various portions of the first sealing member 502.

Referring now to FIG. 5C, a detailed cross-sectional view of part of the first sealing member 502 is shown positioned within the housing groove 450 when the second endplate 218 engages the first groove wall 452. In some implementations, the housing grove 450 has at least one vertical rib 520. The vertical rib 520 can be disposed on either the first groove surface 460 or the second groove surface 464. The vertical rib 520 may include a gap, shown as a rib groove 522. The rib groove 522 can be configured to receive a protrusion (e.g., the first protrusion 507, the second protrusion 508) when the first sealing member 502 is compressed and the protrusion expands radially to engage either the first groove surface 460 or the second groove surface 464. The protrusion can form a seal with the first groove surface 460 or the second groove surface 464 and the vertical rib 520. A rib groove 522 on the first groove surface 460 may be vertically offset from a rib groove 522 disposed on the second groove surface 464. For example, the rib groove 522 on the first groove surface 460 may be disposed a first distance away from the lower end 406 of the shell housing 400, and the rib groove 522 on the second groove surface 464 may be disposed a second distance away from the lower end 406. The first distance may be different than the second distance.

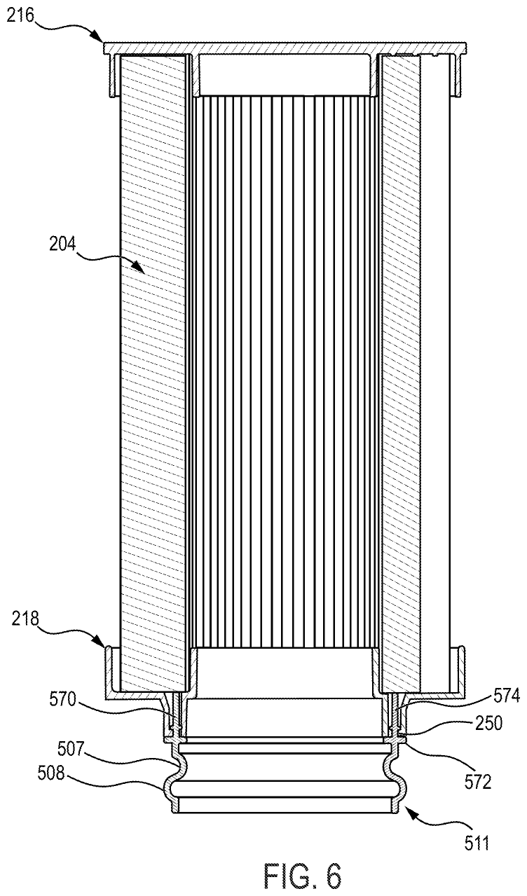

Referring now to FIG. 6, a cross-sectional view of the filter element 202 is shown, according to an example embodiment. The first sealing member 502 includes the bellows member 511 having two protrusions, shown as the first protrusion 507 and the second protrusion 508. The first sealing member 502 is also shown removably coupled to the second endplate 218. Specifically, the second endplate 218 includes a coupling aperture, shown as sealing slot 250, that extends circumferentially about the second endplate 218 and that is configured to receive a portion of the first sealing member 502, shown as a seal coupling flange 570. The seal coupling flange 570 extends axially away from the first sealing member 502 in a direction toward the first endplate 216 and extends into the sealing slot 250. In some embodiments, the seal coupling flange 570 is substantially T-shaped such that the top 572 of the T extends over the sealing slot 250 and the base 574 of the T extends into the sealing slot 250.

### III. Another Example Liquid Filtration System

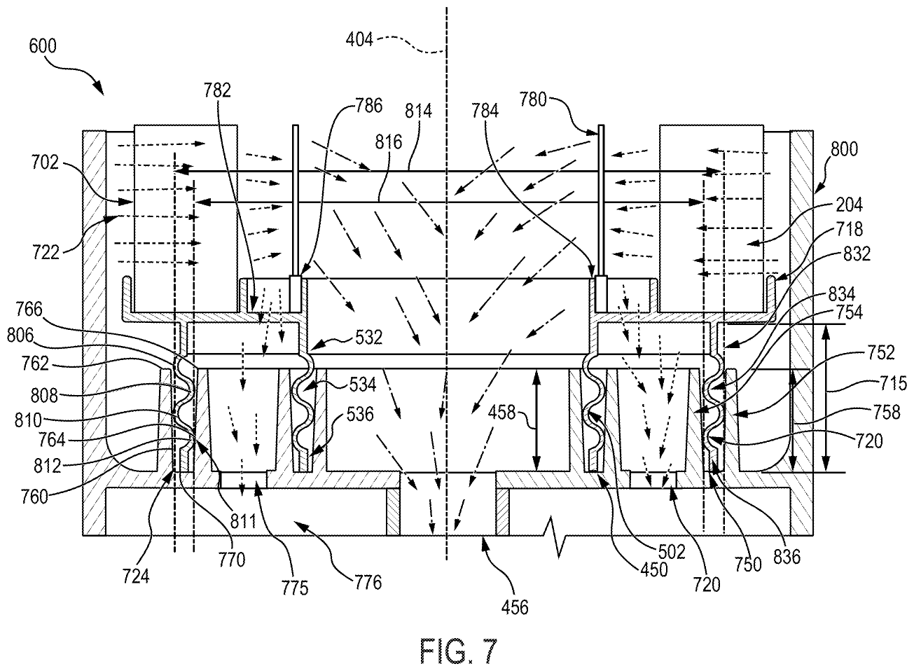

Referring now to FIG. 7, a cross-sectional view of a portion of liquid filtration system 600 is shown, according to another example embodiment. The liquid filtration system 600 is similar to the liquid filtration system 100. Accordingly, like numbering is used to denote like parts. A difference between the liquid filtration system 600 and the liquid filtration system 100 is that the liquid filtration system 600 is configured to separate fuel from water. The system 600 includes a filter element 702 positioned in a shell housing 800. In some embodiments, the filter element 702 and the shell housing 800 are coupled together, for example by fasteners or adhesives, such that separation of the filter element 702 and the shell housing 800 cannot be separated without a physical destruction of one or more components. In some embodiments, the filter element 702 is removably coupled to the shell housing 800 such that the filter element 702 may be removed from the shell housing 800 and replaced with a new filter element.

The filter element 702 is structured to detachably (e.g., removably) couple to the shell housing 800. The filter element 702 includes the first endplate 216 coupled to the first end 212 of the filter element 702 and a second endplate 718 coupled to the second end 214 of the filter element 702. The first endplate 216 and the second endplate 718 may be coupled to the media pack 204 using glue or another suitable bonding agent (e.g., adhesive product) in order to seal the first end 212 and the second end 214 of the media pack 204 and to prevent dirty fluid from bypassing the filter media through the first end 212 and the second end 214. In some embodiments, the first endplate 216 and the second endplate 718 are coupled to the media pack 204 without the use of adhesives. For example, a portion of the first endplate 216 may be heated to a molten state. The media pack 204 may then be plunged into the molten portion of the first endplate 216 to seal the media pack 204 to the first endplate 216. Similarly, a portion of the second endplate 718 may be heated to a molten state. The media pack 204 may then be plunged into the molten portion of the second endplate 718 to seal the media pack 204 to the second endplate 718. Coupling the first endplate 216 and the second endplate 718 in this way may reduce or eliminate the need for using adhesives, potting, or similar compounds to couple the media pack 204 to the first endplate 216 and the second endplate 718.

FIG. 7 shows a cross-sectional view of the second endplate 718. The second endplate 718 includes the first sealing member 502 (e.g., expansible sealing member, expandable sealing member, bellowed sealing member, etc.) extending axially away from the second endplate 718 in a direction opposite to the media pack 204. The first sealing member 502 is configured to extend into a first housing groove 450 (e.g., concentric groove, annular groove, etc.) that extends concentrically about the central axis 404. The first sealing member 502 defines a first seal end 504 coupled to the second endplate 718 and a second seal end 506 positioned opposite to the first seal end 504. A height of the first sealing member 502, shown as a first seal height 515, is defined as a distance between the first seal end 504 and the second seal end 506.

The second endplate 718 further includes a second sealing member 720 (e.g., expansible sealing member, expandable sealing member, bellowed sealing member, etc.) extending axially away from the second endplate 718 in a direction opposite to the media pack 204. The second sealing member 720 is configured to extend into a second housing groove 750 (e.g., concentric groove, annular groove, etc.) that extends concentrically about the central axis 404. The second sealing member 720 defines a first seal end 722 coupled to the second endplate 718 and a second seal end 724 positioned opposite to the first seal end 722. A height of the second sealing member 720, shown as a second seal height 715, is defined as a distance between the first seal end 722 and the second seal end 724. In some embodiments, the first seal height 515 is substantially equal to the second seal height 715. In some embodiments, the second seal height 715 is different from (e.g., greater than, less than) the first seal height 515. The second sealing member 720 defines a diameter greater than a diameter of the first sealing member 502. The second sealing member 720 circumferentially surrounds the first sealing member 502.

The shell housing 800 includes a first housing groove 450 cooperatively defined by a first groove wall 452 and a second groove wall 454. The first groove wall 452 and the second groove wall 454 are concentric about the central axis 404 and extend axially away from the lower end 406 of the shell housing 400 in a direction toward the upper end 416 of the shell housing 400. The first groove wall 452 and the second groove wall 454 extend away from the lower end 406 a distance shown as a first wall height 458. Both the first groove wall 452 and the second groove wall 454 have the first wall height 458. In some embodiments, the first groove wall 452 defines a wall height greater than or less than the wall height of the second groove wall 454. The first wall height 458 is less than the first seal height 515.

The first groove wall 452 includes a first groove surface 460 extending from the lower end 406 to an end 462 of the first groove wall 452. The first groove surface 460 is the radially inward facing surface of the first groove wall 452. The first groove surface 460 may be smooth and continuously extend circumferentially about the first groove wall 452 concentrically about the central axis 404. The first groove surface 460 may be vertical such that a diameter of the first groove surface 460 remains unchanged between the lower end 406 and the end 462. In some embodiments, the first groove surface 460 is slightly tapered toward the lower end 406 such that a diameter of the first groove surface 460 is smaller proximate to the lower end 406 than proximate the end 462.

The second groove wall 454 includes a second groove surface 464 extending from the lower end 406 to an end 466 of the second groove wall 454. The second groove surface 464 is the radially outward-facing surface of the second groove wall 454. The second groove surface 464 may be smooth and continuously extend circumferentially about the second groove wall 454 concentrically about the central axis 404. The second groove surface 464 may be vertical such that a diameter of the second groove surface 464 remains unchanged between the lower end 406 and the end 466. In some embodiments, the second groove surface 464 is slightly tapered toward the end 466 such that a diameter of the second groove surface 464 is larger proximate to the lower end 406 than proximate the end 466.

A third groove surface 470 is positioned proximate to the lower end 406 and is contiguous with both the first groove surface 460 and the second groove surface 464. In some embodiments, the third groove surface 470 is solid and extends continuously about housing groove 450. As will be discussed in greater detail herein, the third groove surface 470 may include apertures, ridges, bumps, and similar features to prevent an axial sealing engagement from being formed with the third groove surface 470. The third groove surface 470 may also include one or more apertures (e.g., drains) that define a flow path for fluid to exit the liquid filtration system 600.

The shell housing 800 further includes a second housing groove 750 cooperatively defined by a first groove wall 752 and a second groove wall 754. The first groove wall 752 and the second groove wall 754 are concentric about the central axis 404 and extend axially away from the lower end 406 of the shell housing 800 in a direction toward the upper end 416 of the shell housing 800. The first groove wall 752 and the second groove wall 754 extend away from the lower end 406 a distance shown as a second wall height 758. Both the first groove wall 752 and the second groove wall 754 have the second wall height 758. In some embodiments, the first groove wall 752 defines a wall height greater than or less than the wall height of the second groove wall 754. The second wall height 758 is less than the second seal height 715. In some embodiments, the first wall height 458 and the second wall height 758 are substantially the same. In some embodiments, the first wall height 458 is different than the second wall height 758.

The first groove wall 752 includes a first groove surface 760 extending from the lower end 406 to an end 762 of the first groove wall 752. The first groove surface 760 is the radially inward facing surface of the first groove wall 752. The first groove surface 760 may be smooth and continuously extend circumferentially about the first groove wall 752 concentrically about the central axis 404. The first groove surface 760 may be vertical such that a diameter of the first groove surface 760 remains unchanged between the lower end 406 and the end 762. In some embodiments, the first groove surface 760 is slightly tapered toward the lower end 406 such that a diameter of the first groove surface 760 is smaller proximate to the lower end 406 than proximate the end 762.

The second groove wall 754 includes a second groove surface 764 extending from the lower end 406 to an end 766 of the second groove wall 454. The second groove surface 764 is the radially outward-facing surface of the second groove wall 754. The second groove surface 764 may be smooth and continuously extend circumferentially about the second groove wall 754 concentrically about the central axis 404. The second groove surface 764 may be vertical such that a diameter of the second groove surface 764 remains unchanged between the lower end 406 and the end 766. In some embodiments, the second groove surface 764 is slightly tapered toward the end 766 such that a diameter of the second groove surface 764 is larger proximate to the lower end 406 than proximate to the end 766.

A third groove surface 770 is positioned proximate to the lower end 406 and is contiguous with both the first groove surface 760 and the second groove surface 764. In some embodiments, the third groove surface 770 is solid and extends continuously about second housing groove 750. As will be discussed in greater detail herein, the third groove surface 770 may include apertures, ridges, bumps, and similar features to prevent an axial sealing engagement from being formed with the third groove surface 770.

Positioned between the first housing groove 450 and the second housing groove 750 is a drain aperture 775. The drain aperture 775 is configured to receive a flow of separated water from the clean side of the shell housing 800 and discharge the flow of water to a sump 776 positioned within the shell housing 800. In some embodiments, such as shown in FIG. 7, the filter element 202 may be an outside-in filter element configured to filter a fluid as the fluid flows axially inward through the media pack 204. Positioned within the media pack 204 and extending circumferentially about the central axis 404 is a hydrophobic screen 780 configured to prevent water from flowing through the screen 780. When water engages the screen 780, the water flows axially downward in a direction toward the second endplate 718. Extending through the second endplate 718 and positioned between the first sealing member 502 and the second sealing member 720 is a plurality of endplate drain apertures 782 configured to allow a flow of water to pass through the second endplate 718. The water that flows through the second endplate 718 then flows between the first housing groove 450 and the second housing groove 750 and through the drain aperture 775 into the sump 776.

The second endplate 718 may include an annular flange, shown as a screen flange 784, that extends axially away from the second endplate 718 in a direction toward the first endplate 216. The screen 780 is coupled to a screen sealing member 786 that extends circumferentially about the screen 780 and is configured to provide a sealing engagement between the screen 780 and the screen flange 784.

The first sealing member 502 can define any projected shape relative to the second endplate 718. For example, in some embodiments, the first sealing member 502 defines an annular body. In other embodiments, the first sealing member 502 may define, for example, an oval body. The shape of the first sealing member 502 may match the shape of the filter element 202 or may have a different configuration. The annular body may include a bellows member 511. The bellows member 511 includes alternating inwardly and outwardly curved protrusions shown as a first protrusion 507 (e.g., inward protrusion), a second protrusion 508 (e.g., outward protrusion), a third protrusion 510 (e.g., inward protrusion), and a fourth protrusion 512 (e.g., outward protrusion). The bellows member 511 facilitates radial expansion of the first sealing member 502 relative to the central axis 404 when the first sealing member 502 is positioned within the housing groove 450. Because the seal height 515 is greater than the wall height 458, the second seal end 506 engages the third groove surface 470 before the second endplate 718 engages the first groove wall 452 and the second groove wall 454 as the first sealing member 502 is extended into the housing groove 450. The filter element 202 is properly set in the shell housing 400 when the second endplate 718 engages one of the first groove wall 452 and the second groove wall 454. Thus, as the second endplate 718 nears the first groove wall 452 and the second groove wall 454, the first sealing member 502 is axially compressed such that the seal height 515 shortens until the seal height 515 is approximately equal to the wall height 458. As the first sealing member 502 is compressed, the bellows member 511 facilitates radial expansion of the first sealing member 502 such that the first sealing member 502 forms a sealing engagement with both the first groove surface 460 and the second groove surface 464.

The second protrusion 508 and the fourth protrusion 512 (e.g., the outward protrusions) cooperatively define an outer seal diameter 514 when the first sealing member 502 is in an uncompressed (e.g., relaxed) state, as shown in FIG. 2. The outer seal diameter 514 is less than the diameter of the first groove surface 460 proximate the end 462 of the first groove wall 452. The first protrusion 507 and the third protrusion 510 (e.g., the inner protrusions) cooperatively define an inner seal diameter 516 when the first sealing member 502 is in an uncompressed state. The inner seal diameter 516 is greater than the diameter of the second groove surface 464 proximate to the end 466 of the second groove wall 454.

In some embodiments, the first sealing member 502 is formed of multiple portions including portions formed of compliant material (e.g., NBR, fluorosilicon, Viton, Nitrile 70 Duro, etc.) and portions formed of a substantially and comparatively rigid material (e.g., plastic, metal, etc.). As shown in FIG. 7, the first sealing member 502 includes a first rigid portion 532 that extends axially away from the second endplate 718 in a direction away from the media pack 204. The first sealing member 502 further includes a first compliant portion 534 coupled to the first rigid portion 532 and having the bellows member 511. Coupled to the first compliant portion 534 opposite to the first rigid portion 532 is a second rigid portion 536. The second rigid portion 536 may be overmolded with the first compliant portion 534 and may prevent damage to the first compliant portion 534. For example, if the filter element 202 is not inserted concentrically within the shell housing 400 during installation, the second seal end 506 may engage a sharp corner of the first groove wall 452 or the second groove wall 454, which may damage the first sealing member 502, and specifically the first compliant portion 534. The second rigid portion 536 may be coupled to the second seal end 506 to prevent damage to the first compliant portion 534 during rough handling or improper installation.

The second sealing member 720 can define any projected shape relative to the second endplate 718. For example, in some embodiments, the second sealing member 720 defines an annular body. In other embodiments, the second sealing member 720 may define, for example, an oval body. The shape of the first sealing member 502 may match the shape of the filter element 202 or may have a different configuration. The annular body may include a bellows member 811. The bellows member 811 includes alternating inwardly and outwardly curved protrusions shown as a first protrusion 806 (e.g., outward protrusion), a second protrusion 808 (e.g., inward protrusion), a third protrusion 810 (e.g., outward protrusion), and a fourth protrusion 812 (e.g., inward protrusion). The bellows member 811 can include any number of protrusions. The bellows member 811 facilitates radial expansion of the second sealing member 720 relative to the central axis 404 when the second sealing member 720 is positioned within the second housing groove 750. The bellows member 811 may have alternating protrusions that alternate in direction opposite to the alternating protrusions of the bellows member 511. For example, while the first protrusion 507 is a radially inwardly extending protrusion, the first protrusion 806 is a radially outwardly extending protrusion. Alternating the protrusions of the bellows member 511 and the bellows member 811 may improve sealing engagement between the filter element 702 and the shell housing 800.

The bellows member 811 facilitates expansion of the second sealing member 720 when the second sealing member 720 is positioned within the second housing groove 750. Because the second seal height 715 is greater than the second wall height 758, the second seal end 724 engages the third groove surface 770 before the second endplate 718 engages the first groove wall 752 as the second sealing member 720 is extended into the second housing groove 750. The filter element 702 is properly set in the shell housing 800 when the second endplate 718 engages one of the first groove wall 752 and the second groove wall 454. Thus, as the second endplate 718 nears the first groove wall 752 and the second groove wall 754, the second sealing member 720 is axially compressed such that the second seal height 715 shortens until the second seal height 715 is approximately equal to the second wall height 758. As the second sealing member 720 is compressed, the bellows member 811 facilitates radial expansion of the second sealing member 720 such that the second sealing member 720 forms a sealing engagement with both the first groove surface 760 and the second groove surface 764.

The first protrusion 806 and the third protrusion 810 (e.g., the outward protrusions) cooperatively define an outer seal diameter 814 when the second sealing member 720 is in an uncompressed (e.g., relaxed) state, as shown in FIG. 7. The outer seal diameter 814 is less than the diameter of the first groove surface 760 proximate the end 762 of the first groove wall 752. The second protrusion 808 and the fourth protrusion 812 (e.g., the inner protrusions) cooperatively define an inner seal diameter 816 when the second sealing member 720 is in an uncompressed state. The inner seal diameter 816 is greater than the diameter of the second groove surface 764 proximate to the end 766 of the second groove wall 754.

In some embodiments, the second sealing member 720 is formed of multiple portions including portions formed of compliant material (e.g., NBR, fluorosilicon, Viton, Nitrile 70 Duro, etc.) and portions formed of a substantially and comparatively rigid material (e.g., plastic, metal, etc.). As shown in FIG. 7, the second sealing member 720 includes a first rigid portion 832 that extends axially away from the second endplate 718 in a direction away from the media pack 204. The second sealing member 720 further includes a first compliant portion 834 coupled to the first rigid portion 832 and having the bellows member 811. Coupled to the first compliant portion 834 opposite to the first rigid portion 832 is a second rigid portion 836. The second rigid portion 836 may be overmolded with the first compliant portion 834 and may prevent damage to the first compliant portion 834. For example, if the filter element 702 is not inserted concentrically within the shell housing 800 during installation, the second seal end 724 may engage a sharp corner of the first groove wall 752 or the second groove wall 754, which may damage the second sealing member 720, and specifically the first compliant portion 834. The second rigid portion 836 may be coupled to the second seal end 724 to prevent damage to the first compliant portion 834 during rough handling or improper installation.

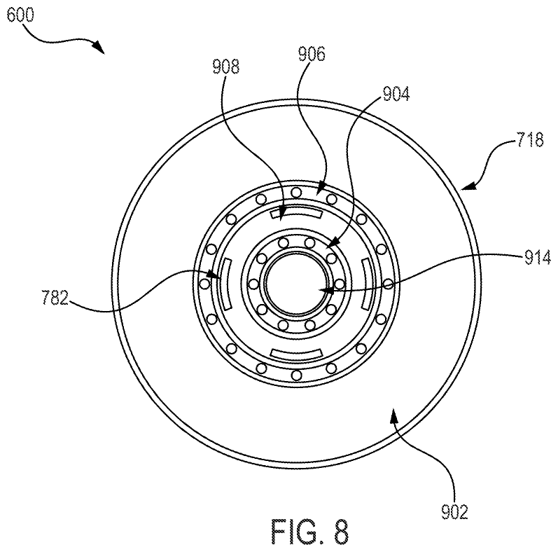

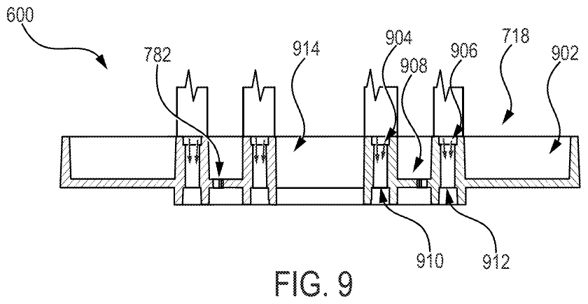

Referring now to FIGS. 8 and 9, the second endplate 718 is shown, according to an example embodiment. As shown in FIG. 8, the second endplate 718 includes a media cavity 902 for receiving the media pack 204, a first coupling groove 904 for coupling with the first sealing member 502, a second coupling groove 906 for coupling with the second sealing member 720, and a drain groove 908 having the drain apertures 782. Extending through the second endplate 718 within the first coupling groove 904 are a plurality of first coupling apertures 910 configured to receive a portion of the first sealing member 502. Specifically, the first sealing member 502 may be overmolded with the second endplate 718 via the first coupling apertures 910. Similarly, extending through the second endplate 718 within the second coupling groove 906 are a plurality of second coupling apertures 912 configured to receive a portion of the second sealing member 720. Specifically, the second sealing member 720 may be overmolded with the second endplate 718 via the second coupling apertures 912. In some embodiments, the first sealing member 502 and the second sealing member 720 are coupled to (e.g., mechanically attached, chemically bonded, adhered to, etc.) the second endplate 718 via the first and second coupling apertures 910, 912, respectively.

FIG. 9 is a cross-sectional view of the second endplate 718, which shows both the first coupling apertures 910 and the second coupling apertures 912 extending all the way through the second endplate 718. Extending through a center portion of the second endplate 718 is an outlet aperture 914 configured to receive a flow of clean fluid, such as clean fuel from a clean side of the filter element 202. The outlet aperture 914 is centered on the central axis 404.

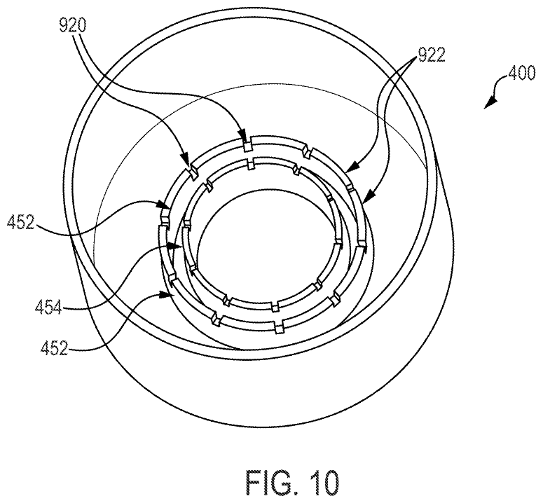

Referring generally to FIGS. 10-14 and 23-28, various configurations which may be used for the lower end 406 or the upper end 416 of the shell housing 400 and the shell housing 800 are shown, according to example embodiments. Various features may be added to the shell housing 400, 800 to prevent the use of unauthorized filter elements from forming a seal with the lower end 406 of the shell housing 400, 800. Although the various configurations are discussed with respect to the lower end 406, the upper end 416 may also comprise the various configurations such that the first endplate 216 can provide the same sealing functions as the second endplate 218. Therefore, the disclosure provided herein is equally applicable to the upper end 416 of the shell housing 400 and the shell housing 800.

Referring to FIG. 10, a perspective cut-away view of the lower end 406 of the shell housing 400 is shown, according to an example embodiment. The first groove wall 452 and the second groove wall 454 include a plurality of notches 920. The plurality of notches 920 separate the ends 462, 466 of the first groove wall 452 and the second groove wall 454 into a plurality of discrete wall projections 922. The wall projections prevent an axial seal from forming a sealing engagement with the ends 462, 466 of the first groove wall 452 and the second groove wall 454 as fluid is allowed to flow through the plurality of notches 920. However, the first sealing member 502 is configured to form a sealing engagement with the housing groove 450, as the plurality of notches 920 do not affect the sealing engagement formed between the first sealing member 502 and the shell housing 400. While FIG. 10 only shows the first groove wall 452 and the second groove wall 454 that define the first housing groove 450 of the liquid filtration system 100, it should be understood that similar features may be formed in the first groove wall 752 and the second groove wall 754 that define the second housing groove 750 of the liquid filtration system 600.

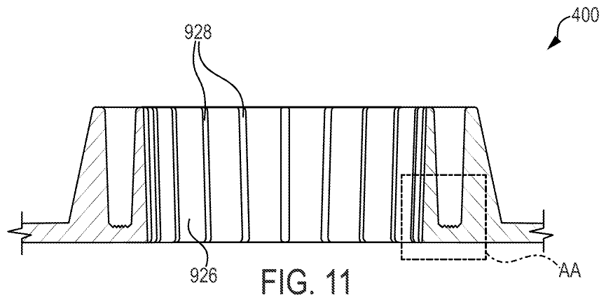

Referring now to FIG. 11, a cross-sectional view of the lower end 406 of the shell housing 400 is shown, according to an example embodiment. A radially inward surface of the second groove wall 454, shown as an inner aperture surface 926, is interrupted by a plurality of vertical grooves 928 that extend from the end 466 of the second groove wall 454 to the lower end 406 of the shell housing 400, 800. The vertical grooves 928 prevent a radial seal from forming a sealing engagement with the inner aperture surface 926, as the fluid may flow through the vertical grooves 928.

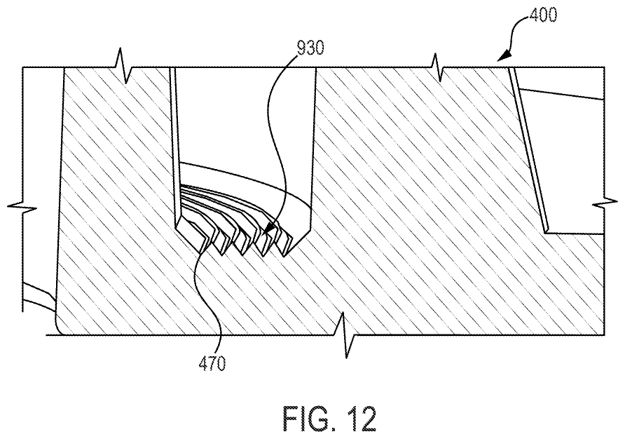

Referring now to FIG. 12, a detailed cross-sectional view of the portion of the shell housing 400 shown in window AA of FIG. 11 is shown. The third groove surface 470, 770 includes a plurality of ridges 930 that frustrate an axial seal from forming a sealing engagement with the third groove surface 470, 770.

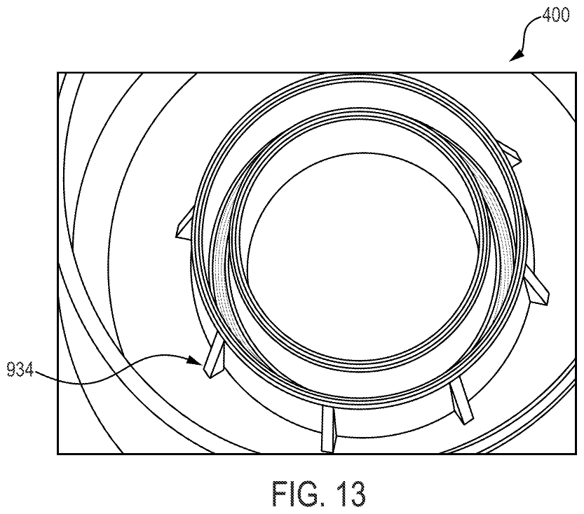

Referring now to FIG. 13, a perspective detailed view of the lower end 406 of the shell housing 400 of FIG. 11 is shown. A plurality of buttresses 934 (e.g., ribs, projections, etc.) are profiled radially about the first groove wall 452 and extend radially outward from the first groove wall 452 proximate to the lower end 406. The buttresses 934 may have a slope with respect to the first groove wall 452 such that a bottom portion of the buttresses 934 extends further away from the first groove wall 452 than a top portion of the buttresses 934. The plurality of buttresses 934 prevent an unauthorized fluid filter from extending about the first groove wall 452, 752 and forming an axial seal with the lower end 406 of the shell housing 400, 800 radially away from the first groove wall 452, 752. While FIGS. 11-13 only show the first groove wall 452 and the second groove wall 454 that define the first housing groove 450 of the liquid filtration system 100, it should be understood that similar features, such as the plurality of vertical grooves 928, the ridges 930, and the plurality of buttresses 934, may be formed in the first groove wall 752 and the second groove wall 754 that define the second housing groove 750 of the liquid filtration system 600.

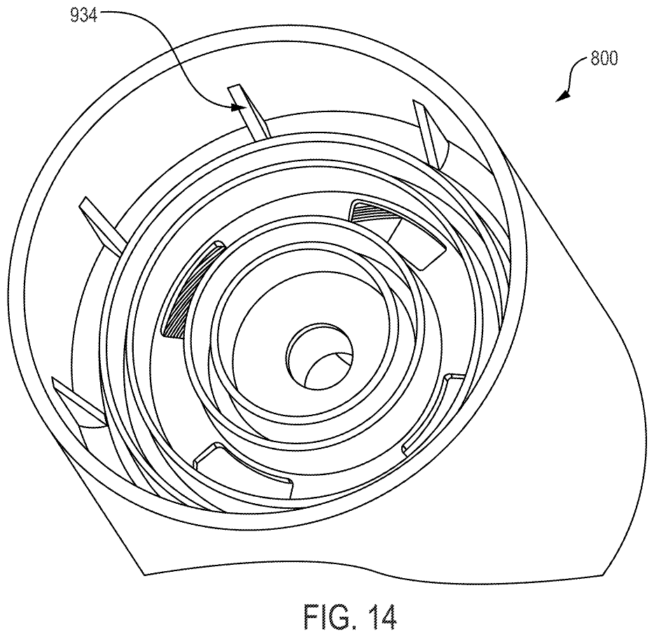

Referring now to FIG. 14, a perspective detailed view of the lower end 406 of the shell housing 800 is shown, according to another example embodiment. The plurality of buttresses 934 extend radially inward from a sidewall 408 of the shell housing 800 proximate to the lower end 406. The buttresses 934 may have a slope with respect to the sidewall 408 such that a bottom portion of the buttresses 934 extends further away from the sidewall 408 than a top portion of the buttresses 934. The plurality of buttresses 934 prevent an axial or radial seal from being formed at a surface of the sidewall 408 proximate to the lower end 406. While FIG. 14 only shows the shell housing 800, it should be understood that similar features may be formed in the shell housing 400.

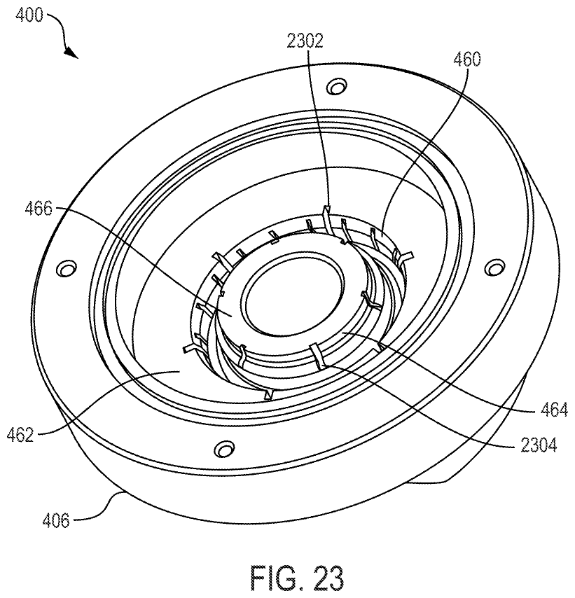

Referring now to FIG. 23, a perspective view of the lower end 406 of the shell housing 400 is shown, according to another example embodiment. The first groove surface 460 has a plurality of outer vertical channels 2302 and the second groove surface 464 includes a plurality of inner vertical channels 2304. The outer vertical channels 2302 can extend from the end 462 of the first groove wall 452 toward the lower end 406. The outer vertical channels 2302 may also extend radially outward along the end 462 of the first groove wall 452 toward the sidewall 408 of the shell housing 400. For example, the outer vertical channels 2302 may extend radially 3 mm along the end 462 of the first groove wall 452. The inner vertical channels 2304 can extend from the end 466 of the second groove wall 454 toward the lower end 406. The outer vertical channels 2302 are offset from the inner vertical channels 2304. The outer vertical channels 2302 and the inner vertical channels 2304 may have the same depth. For example, the outer vertical channels 2302 and the inner vertical channels 2304 may have a depth of 1 mm. The outer vertical channels 2302 and the inner vertical channels 2304 may also have different depths (and different depths from each other). The outer vertical channels 2302 and the inner vertical channels 2304 prevent a radial seal from forming a sealing engagement with the first groove surface 460 and the second groove surface 464 at certain axial locations, as fluid may flow through the outer vertical channels 2302 and the inner vertical channels 2304.

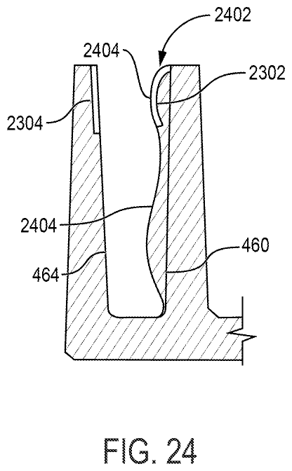

Referring now to FIG. 24, a detailed view of the lower end 406 of the shell housing 400 of FIG. 23 is shown, according to an example embodiment. The first groove surface 460 includes a bump feature 2402. The bump feature 2402 includes at least one bump 2404 that extends away from the first groove surface 460 into the housing groove 450. The bump feature 2402 frustrates sealing at an unintended surface location. The first groove surface 460 includes one or more outer vertical channels 2302 that follow the geometry of the bump feature 2402.

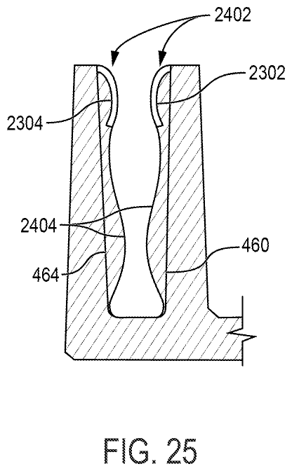

Referring now to FIG. 25, a detailed view of the lower end 406 of the shell housing 400 of FIG. 23 is shown, according to another example embodiment. Both the first groove surface 460 and the second groove surface 464 include a bump feature 2402. The bump feature 2402 of the first groove surface 460 includes at least one bump 2404 that extends away from the first groove surface 460 into the housing groove 450. The bump feature 2402 of the second groove surface 464 includes at least one bump 2404 that extends away from the second groove surface 464 into the housing groove 450. The bump features 2402 frustrate an axial seal from forming a sealing engagement with the first groove surface 460 and the second groove surface 464. The first groove surface 460 includes one or more outer vertical channels 2302 that follow the geometry of the bump feature 2402 of the first groove surface 460. The second groove surface 464 includes one or more inner vertical channels 2304 that follow the geometry of the bump feature 2402 of the second groove surface 464.

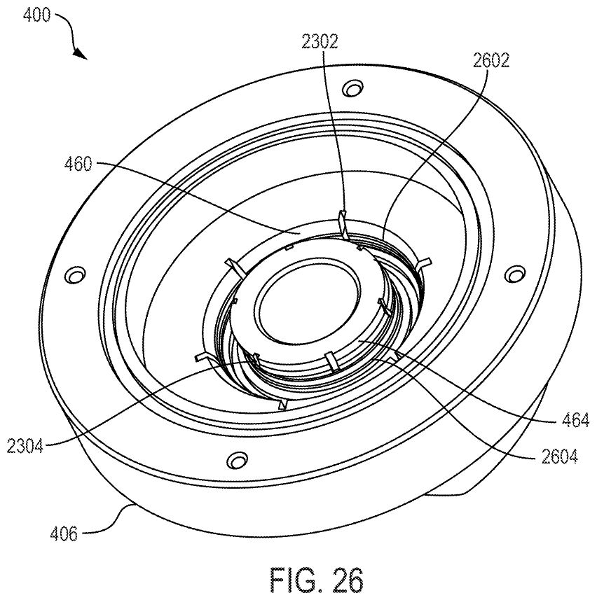

Referring now to FIG. 26, a perspective view of the lower end 406 of the shell housing 400 of FIG. 23 is shown, according to another example embodiment. The first groove surface 460 includes one or more outer horizontal notches 2602. The second groove surface 464 includes one or more inner horizontal notches 2604. The outer horizontal notches 2602 and the inner horizontal notches 2604 may extend radially into the respective first groove surfaces 460 and second groove surface 464 the same distance. For example, the outer horizontal notch 2602 may extend radially into the first groove surface 460 1 mm and the inner horizontal notch 2604 may extend radially into the second groove surface 464 1 mm. The distances can vary. The outer horizontal notches 2602 and the inner horizontal notches 2604 extend continuously along the respective groove surfaces 460, 464.

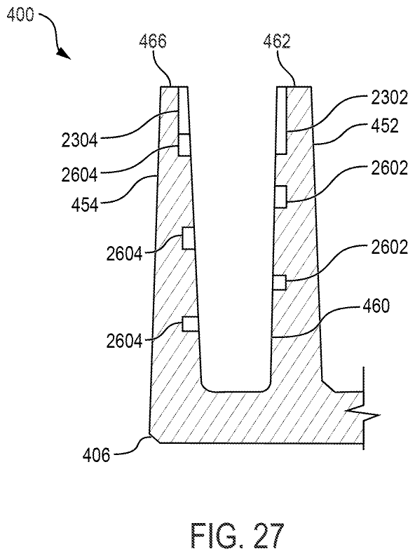

Referring now to FIG. 27, a detailed view of the lower end 406 of the shell housing 400 of FIG. 26 is shown, according to an example embodiment. The outer horizontal notch 2602 is vertically offset from the inner horizontal notch 2604. For example, the outer horizontal notch 2602 may be disposed a first distance away from the lower end 406 of the shell housing and the inner horizontal notch 2604 may be disposed a second distance away from the lower end 406. The first distance may be different than the second distance. A height of the outer horizontal notches 2602 and the inner horizontal notches 2604 may be the same. For example, the height of the outer horizontal notches 2602 and the height of the inner horizontal notches 2604 may be 1 mm. The height may also be greater or less than 1 mm.

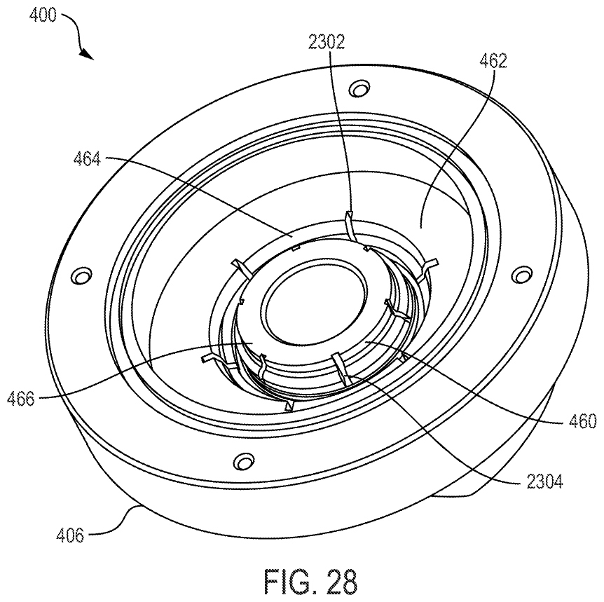

Referring now to FIG. 28, a perspective view of the lower end 406 of the shell housing 400 of FIG. 23 is shown, according to another example embodiment. The end 462 of the first groove wall 452 and the end 466 of the second groove wall 454 are chamfered. The outer vertical channels 2302 follow the geometry of the chamfered end 462 of the first groove wall 452 and the inner vertical channels 2304 follow the geometry of the chamfered end 466 of the second groove wall 454.

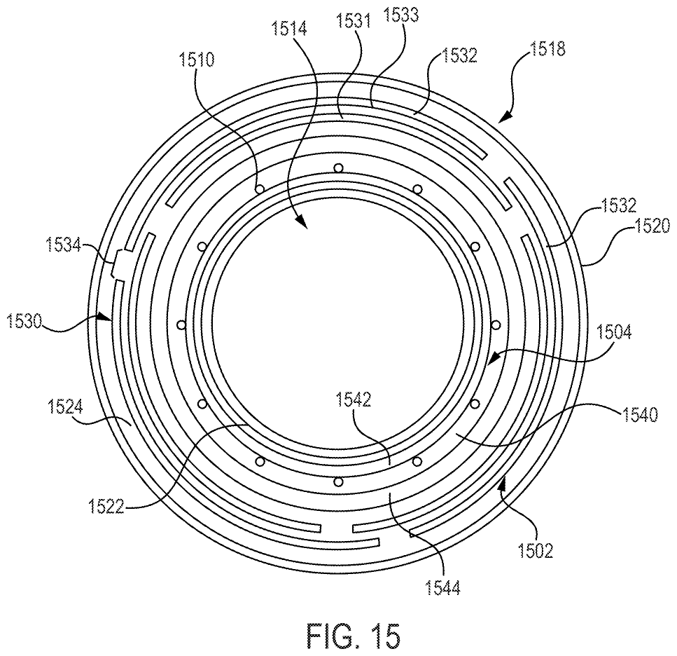

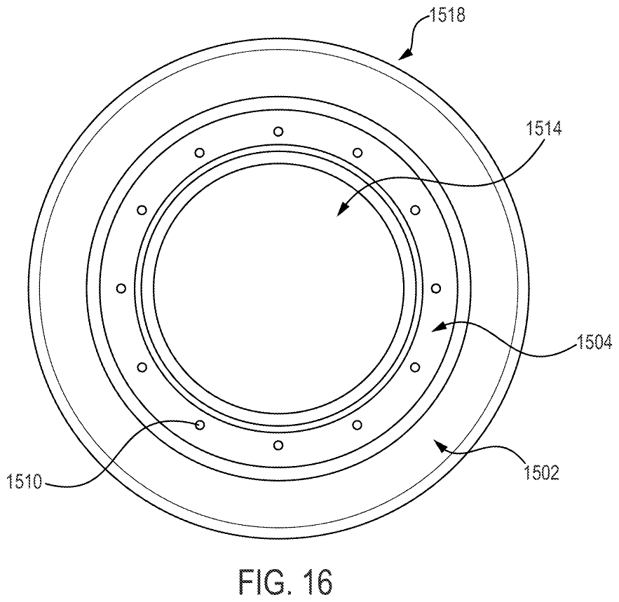

Referring now to FIGS. 15-18, a second endplate 1518 is shown, according to an example embodiment. The second endplate 1518 is similar to second endplate 718. Accordingly, like numbering is used to denote like parts. As shown in FIGS. 15-16, the second endplate 1518 includes a media cavity 1502 for receiving the media pack 204 and a coupling groove 1504 for coupling with the first sealing member 502. Extending through a center portion of the second endplate 1518 is an outlet aperture 1514 configured to receive a flow of clean fluid, such as clean fuel from a clean side of the filter element 202. The outlet aperture 1514 is centered on the central axis 404, although the outlet aperture 1514 may not be centered in other embodiments.

The media cavity 1502 is defined by a first side wall, shown as an outer sidewall 1520, a second sidewall, shown as an inner sidewall 1522, and a bottom surface 1524. The outer sidewall 1520 is disposed apart from the inner sidewall 1522. The outer sidewall 1520 extends continuously around the media cavity 1502. The inner sidewall 1522 continuously extends around the outlet aperture 1514. The outer sidewall 1520 has a first diameter 1526. The inner sidewall 1522 has a second diameter 1528. The first diameter 1526 is larger than the second diameter 1528. The outer sidewall 1520 and the inner sidewall 1522 may extend substantially vertically (e.g., substantially parallel with the central axis 404). In some embodiments, the outer sidewall 1520 and the inner sidewall 1522 extend at an angle with respect to the central axis 404. The outer sidewall 1520 and the inner sidewall 1522 have the same height.

At least a portion of the bottom surface 1524 extends from the outer sidewall 1520 toward the inner sidewall 1522 (e.g., an outer portion of the bottom surface 1524). Another portion of the bottom surface 1524 may extend from the inner sidewall 1522 toward the outer sidewall 1520 (e.g., an inner portion of the bottom surface 1524). The outer portion of the bottom surface 1524 includes one or more ribs 1530 extending from the bottom surface 1524 toward the media pack 204. Each rib 1530 is configured to facilitate flow of various fluids (e.g., adhesives, epoxy) within the second endplate 1518 and facilitate creation of a strong adhesion between the media pack 204 and the second endplate 1518. The ribs 1530 may continuously extend about the coupling groove 1504. In some embodiments, the ribs 1530 comprise a plurality of segments 1532 such that the ribs 1530 are not continuous about the coupling groove 1504. For example, the ribs 1530 may include a plurality of segments 1532 that extend around a majority of the coupling groove 1504 with a gap 1534 between each segment 1532. The segments 1532 can be the same size or different sizes.

The bottom surface 1524 may comprise a plurality of ribs 1530. For example, the bottom surface 1524 may have a first rib 1531 and a second rib 1533. The first rib 1530 may be positioned radially interior of the second rib 1533. For example, the first rib 1531 may be disposed closer to the coupling groove 1504 than the second rib 1533. Some, all, or none of the ribs 1530 may comprise a plurality of segments 1532. For example, the first rib 1531 may comprise three segments 1532 and the second rib 1533 may comprise three segments 1532. The gaps 1534 between the segments 1532 of the first rib 1531 may be offset from the gaps 1534 between the segments 1532 of the second rib 1533.

The coupling groove 1504 of the second endplate 1518 continuously extends circumferentially about the outlet aperture 1514 of the second endplate 1518. The coupling groove 1504 is disposed between an inner most rib 1530 and the inner sidewall 1522. A space between the inner portion and the outer portion of the bottom surface 1524 defines a first end 1536 of the coupling groove 1504. A second end 1538 of the coupling groove 1504 is defined by a base surface 1540. The base surface 1540 is offset (e.g., below) the bottom surface 1524 of the media cavity 1502. The coupling groove 1504 is further defined by an inner wall 1542 and an outer wall 1544. The inner wall 1542 extends from an edge of the inner portion of the bottom surface 1524 of the media cavity 1502 in a direction away from the media cavity 1502. The outer wall 1544 extends from an edge of the outer portion of the bottom surface 1524 of the media cavity 1502 in a direction away from the media cavity 1502. The second end 1538 of the coupling groove 1504 is smaller than the first end 1536 such that at least a portion of the inner wall 1542 and/or the outer wall 1544 is angled with respect to the central axis 404. The inner wall 1542 has a third diameter 1546. The outer wall 1544 has a fourth diameter 1548. The third diameter 1546 is smaller than the fourth diameter 1548. The third diameter 1546 is larger than the second diameter 1528 such that the outlet aperture 1514 has two diameters. For example, a first portion of the outlet aperture 1514 has a diameter equal to the second diameter 1528 and a second portion of the outlet aperture 1514 has a diameter equal to the third diameter 1546. The third diameter 1546 and the fourth diameter 1548 are smaller than the first diameter 1526.

The base surface 1540 comprises a plurality of coupling apertures 1510 configured to receive a portion of the first sealing member 502. The coupling apertures 1510 are configured to extend from the base surface 1540 of the coupling groove 1504 through a bottom of the second endplate 1518. The coupling apertures 1510 may be disposed symmetrically around the outlet aperture 1514 within the coupling groove 1504. For example, each of the coupling apertures 1510 may be spaced the same distance apart from adjacent coupling apertures 1510. In some embodiments, the coupling apertures 1510 are disposed in a non-symmetrical arrangement. For example, the distance between adjacent coupling apertures 1510 may vary or one side of the second endplate 1518 may have more coupling apertures 1510 than the other side.

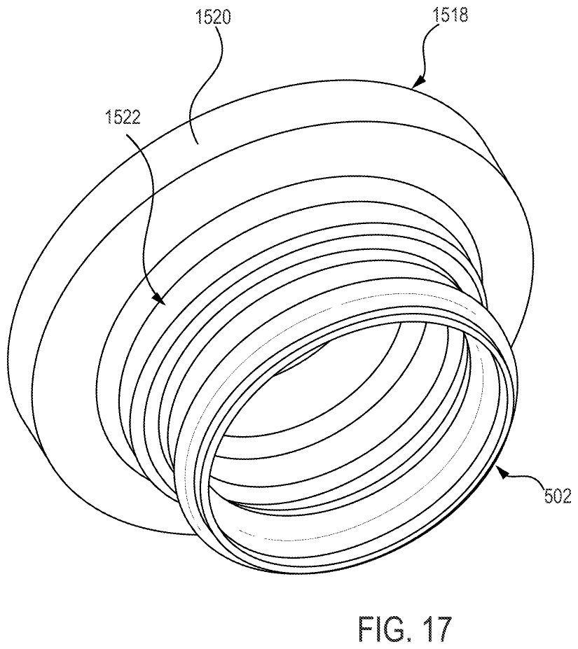

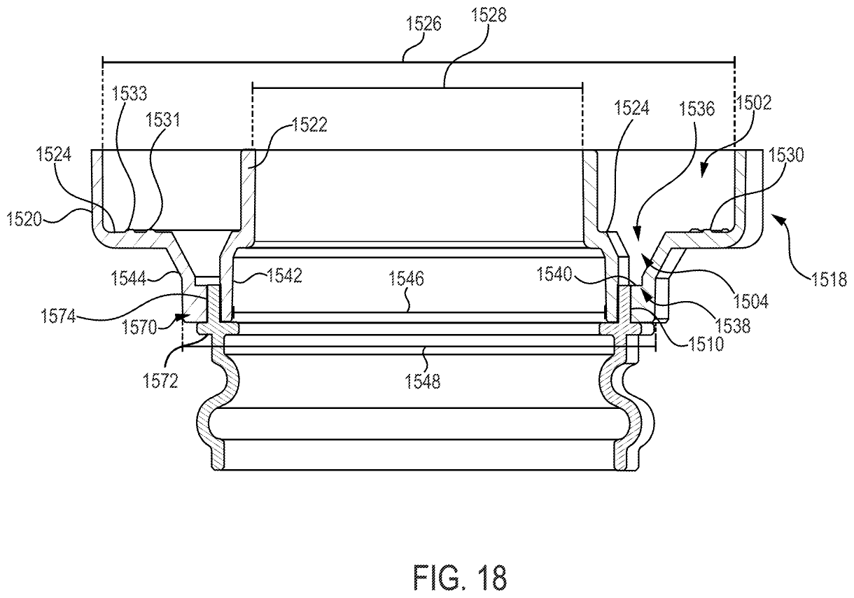

As shown in FIGS. 17-18, the second endplate 1518 is coupled to the first sealing member 502. The first sealing member 502 may be removably coupled to the second endplate 1518. In some embodiments, the first rigid portion 532 of the first sealing member 502 comprises a plurality of coupling posts 1570 that correspond with the plurality of coupling apertures 1510 of the second endplate 1518. For example, the coupling apertures 1510 are configured to receive a corresponding coupling post 1570 of the first sealing member 502. The coupling posts 1570 are substantially T-shaped comprising a top 1572 of the T and a base 1574 of the T. The top 1572 extends over the coupling aperture 1510 and the base 1574 extends into the coupling aperture 1510. In some embodiments, the base 1574 extends through the second endplate 1518 to the base surface 1540 of the coupling groove 1504. For example, an end of the base 1574 may be flush with (e.g., in the same plane as) the base surface 1540 when the first sealing member 502 is coupled to the second endplate 1518. In some embodiments, the base 1574 extends beyond the base surface 1540 and into the coupling groove 1504. For example, the base 1574 may extend until the end of the base 1574 is flush with the bottom surface 1524 of the media cavity 1502. The end of the base 1574 may also be disposed between the base surface 1540 and the bottom surface 1524, or below the base surface 1540.

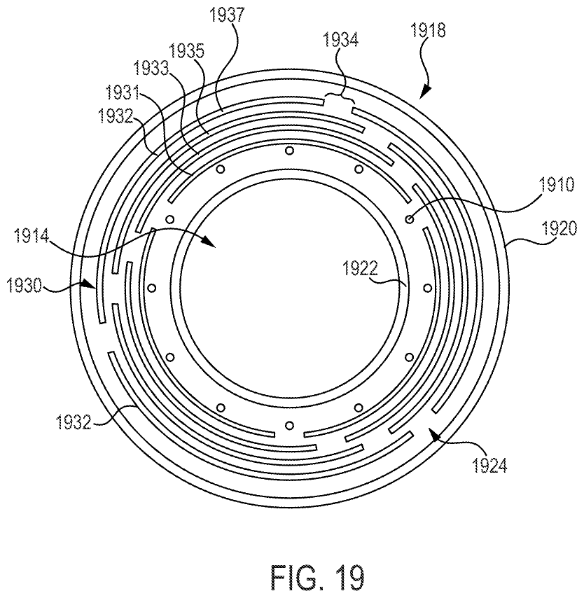

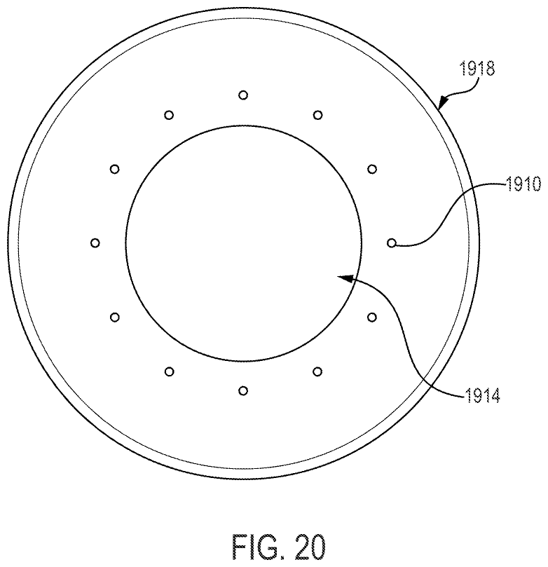

Referring now to FIGS. 19-22, a second endplate 1918 is shown, according to an example embodiment. The second endplate 1918 is similar to the second endplate 1518. Accordingly, like numbering is used to denote like parts. As shown in FIGS. 19-20, the second endplate 1918 includes a media cavity 1902 for receiving the media pack 204. Extending through a center portion of the second endplate 1918 is an outlet aperture 1914 configured to receive a flow of clean fluid, such as clean fuel from a clean side of the filter element 202. The outlet aperture 1914 is centered on the central axis 404.

The media cavity 1902 is defined by a first side wall, shown as outer sidewall 1920, a second sidewall, shown as inner sidewall 1922, and a bottom surface 1924. The outer sidewall 1920 continuously extends around the media cavity 1902. The inner sidewall 1922 continuously extends around the outlet aperture 1914. The outer sidewall 1920 has a first diameter 1926. The inner sidewall 1922 has a second diameter 1928. The first diameter 1926 is larger than the second diameter 1928. The outer sidewall 1920 and the inner sidewall 1922 may extend substantially vertically (e.g., substantially parallel with the central axis 404). In some embodiments, the outer sidewall 1920 and the inner sidewall 1922 extend at an angle with respect to the central axis 404. The outer sidewall 1920 and the inner sidewall 1922 have the same height.

The bottom surface 1924 extends from the outer sidewall 1920 to the inner sidewall 1922. The bottom surface 1924 includes one or more ribs 1930 extending from the bottom surface 1924 toward the media pack 204. Each rib 1930 is configured to facilitate flow of various fluids (e.g., adhesives, epoxy) within the second endplate 1518 and facilitate creation of a strong adhesion between the media pack 204 and the second endplate 1518. The rib 1930 may continuously extend about the outlet aperture 1914. In some embodiments, the rib 1930 comprises a plurality of segments 1932 such that the rib 1930 is not continuous about the outlet aperture 1914. For example, the rib 1930 may include a plurality of segments 1932 that extend around a majority of the outlet aperture 1914 with a gap 1934 between each segment 1932. The segments 1932 can be the same size or different sizes.

The bottom surface 1924 may comprise a plurality of ribs 1930. For example, the bottom surface 1924 may have a first rib 1931, a second rib 1933, a third rib 1935, and a fourth rib 1937. The first rib 1931 may be positioned radially interior of the second rib 1933 and disposed closest to the outlet aperture 1914. The second rib 1933 may have a diameter larger than the first rib 1931 and be positioned radially interior of the third rib 1935. The third rib 1935 may have a larger diameter than the second rib 1930 and may be positioned radially interior of the fourth rib 1937. The fourth rib 1937 may be have a larger diameter than the third rib 1935 and be disposed farthest away from the outlet aperture 1914. Some, all, or none of the ribs 1930 may comprise a plurality of segments 1932. For example, the first, second, third, and fourth ribs 1931, 1933, 1935, 1937 each may comprise three segments 1932. The gaps 1934 between the segments 1932 of a rib 1930 may be offset from the gaps 1934 between the segments 1932 of an adjacent rib 1930.

The bottom surface 1924 comprises a plurality of coupling apertures 1910 configured to receive a portion of the first sealing member 502. The coupling apertures 1910 are configured to extend from the bottom surface 1924 through the second endplate 1918. The coupling apertures 1910 may be disposed symmetrically around the outlet aperture 1914. For example, each of the coupling apertures 1910 may be spaced the same distance apart from adjacent coupling apertures 1910. In some embodiments, the coupling apertures 1910 are disposed in a non-symmetrical arrangement. For example, the distance between adjacent coupling apertures 1910 may vary or one side of the second endplate 1918 may have more coupling apertures 1910 than the other. The coupling apertures 1910 are disposed inward of the inner most rib 1930.

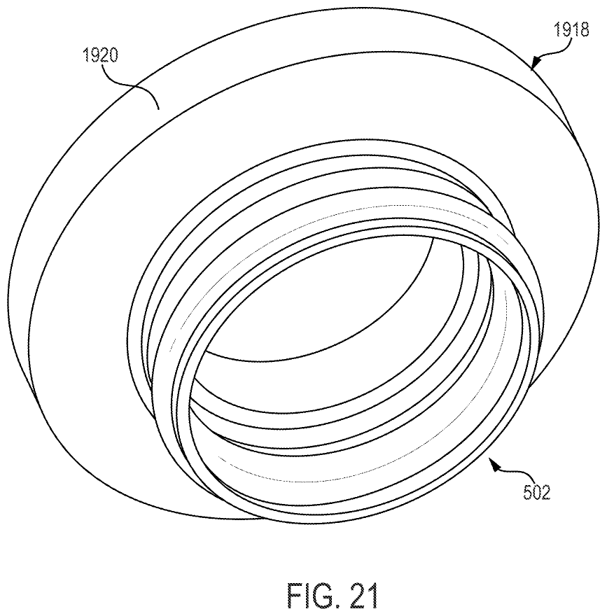

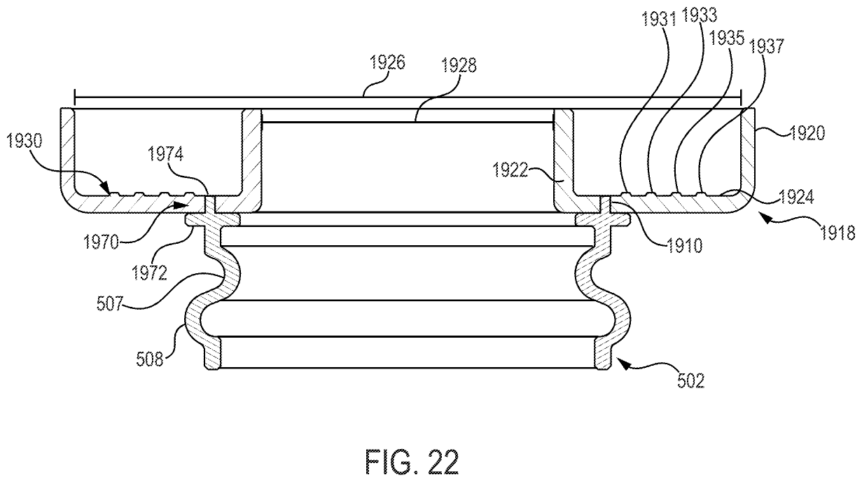

As shown in FIGS. 21-22, the second endplate 1918 is coupled to the first sealing member 502. The first sealing member 502 may be removably coupled to the second endplate 1918. In some embodiments, the first rigid portion 532 of the first sealing member 502 comprises a plurality of coupling posts 1970 that correspond with the plurality of coupling apertures 1910 of the second endplate 1918. For example, the coupling apertures 1910 are configure to receive a corresponding coupling post 1970 of the first sealing member 502. The coupling posts 1970 are substantially T-shaped comprising a top 1972 of the T and a base 1974 of the T. The top 1972 extends over the coupling aperture 1910 and the base 1974 extends into the coupling aperture 1910. The base 1974 may extend through the second endplate 1918 such that an end of base 1974 aligns with (e.g., is flush with, is within the same plane as) the bottom surface 1924 of the media cavity 1902. In some embodiments, the end of the base 1974 is disposed above or below the bottom surface 1924 when the first sealing member 502 is coupled to the second endplate 1918.

While this specification contains many specific implementation details, these should not be construed as limitations on the scope of what may be claimed but rather as descriptions of features specific to particular implementations. Certain features described in this specification in the context of separate implementations can also be implemented in combination in a single implementation. Conversely, various features described in the context of a single implementation can also be implemented in multiple implementations separately or in any suitable subcombination. Moreover, although features may be described as acting in certain combinations and even initially claimed as such, one or more features from a claimed combination can, in some cases, be excised from the combination, and the claimed combination may be directed to a subcombination or variation of a subcombination.

As utilized herein, the terms “approximately,” “substantially” and similar terms are intended to have a broad meaning in harmony with the common and accepted usage by those of ordinary skill in the art to which the subject matter of this disclosure pertains. It should be understood by those of skill in the art who review this disclosure that these terms are intended to allow a description of certain features described and claimed without restricting the scope of these features to the precise numerical ranges provided. Accordingly, these terms should be interpreted as indicating that insubstantial or inconsequential modifications or alterations of the subject matter described and claimed are considered to be within the scope of the invention as recited in the appended claims.

The terms “coupled,” “attached,” and the like, as used herein, mean the joining of two components directly or indirectly to one another. Such joining may be stationary (e.g., permanent) or moveable (e.g., removable or releasable). Such joining may be achieved with the two components or the two components and any additional intermediate components being integrally formed as a single unitary body with one another, with the two components, or with the two components and any additional intermediate components being attached to one another.

The term “or” is used in its inclusive sense (and not in its exclusive sense) so that when used, for example, to connect a list of elements, the term “or” means one, some, or all of the elements in the list. Conjunctive language such as the phrase “at least one of X, Y, and Z,” unless specifically stated otherwise, is otherwise understood with the context as used in general to convey that an item, term, etc. may be either X, Y, Z, X and Y, X and Z, Y and Z, or X, Y, and Z (i.e., any combination of X, Y, and Z). Thus, such conjunctive language is not generally intended to imply that certain embodiments require at least one of X, at least one of Y, and at least one of Z to each be present, unless otherwise indicated.

It is important to note that the construction and arrangement of the system shown in the various example implementations is illustrative only and not restrictive in character. All changes and modifications that come within the spirit and/or scope of the described implementations are desired to be protected. It should be understood that some features may not be necessary, and implementations lacking the various features may be contemplated as within the scope of the application, the scope being defined by the claims that follow. When the language a “portion” is used, the item can include a portion and/or the entire item unless specifically stated to the contrary.

What is claimed is:

1. A fluid filtration system, comprising:
a filter head; and
a filter cartridge removably coupled to the filter head, the filter cartridge comprising:
a shell housing defining a first housing end, a second housing end, and a housing sidewall extending between the first housing end and the second housing end; and
a filter element received within the shell housing and removably coupled to the shell housing, the filter element comprising:
a media pack configured to filter matter from a fluid flowing therethrough; and
an endplate coupled to an end of the media pack, the endplate comprising a sealing member extending axially away from the endplate in a direction opposite to the media pack and having a compliant portion.

2. The fluid filtration system of claim 1, wherein the shell housing comprises a first groove wall and a second groove wall extending axially away from the second housing end in a direction toward the first housing end, the first groove wall and the second groove wall extending to a first height, the first groove wall and the second groove wall cooperating to define a housing groove therebetween, the housing groove receiving the sealing member.

3. The fluid filtration system of claim 2, wherein the sealing member extends from the endplate a second height, the second height being greater than the first height.

4. The fluid filtration system of claim 2, wherein the compliant portion includes a bellows member configured to permit radial expansion of the sealing member when the sealing member extends into the housing groove.

5. The fluid filtration system of claim 2, wherein the sealing member comprises:
a first rigid portion extending axially from the endplate in the direction opposite to the media pack;
a second rigid portion coupled to an end of the sealing member opposite to the endplate; and
the compliant portion interposed between and coupled to both the first rigid portion and the second rigid portion.

6. The fluid filtration system of claim 5, wherein the second rigid portion defines an annular ring body, the annular ring body sized to rest flush against a bottom surface of the housing groove when the sealing member is disposed within the housing groove.

7. The fluid filtration system of claim 2, wherein the shell housing further comprises:
a sidewall; and
a plurality of buttresses extending radially between the first groove wall and the sidewall, the plurality of buttresses configured to prevent an unauthorized fluid filter from forming an axial or radial seal at the second housing end.

8. The fluid filtration system of claim 1, wherein:
the endplate comprises a plurality of coupling apertures; and
the sealing member comprises a plurality of coupling posts that correspond with the plurality of coupling apertures, the plurality of coupling apertures configured to receive the corresponding coupling posts to couple the sealing member to the endplate.

9. The fluid filtration system of claim 1, wherein the endplate comprises:
a media cavity defined by a first wall, a second wall, and a bottom surface, the media cavity configured to receive the media pack, and the first wall defining at least a portion of an outlet aperture;
a plurality of ribs extending around the outlet aperture; and
a plurality of coupling apertures extending around the outlet aperture, the plurality of coupling apertures extending through the endplate.

10. The fluid filtration system of claim 9, wherein the endplate further comprises a coupling groove disposed between an inner most rib and the first wall, the coupling groove comprising the plurality of coupling apertures.

11. A filter cartridge comprising:
a generally cylindrical shell housing defining a central axis, the shell housing comprising:
a first housing end;
a second housing end opposite to the first housing end;
a housing sidewall extending between the first housing end and the second housing end, the housing sidewall including an inner housing surface and an outer housing surface; and
a first groove wall and a second groove wall extending axially away from the second housing end in a direction toward the first housing end, the first groove wall and the second groove wall extending to a first height, and the first groove wall and the second groove wall cooperating to define a housing groove therebetween; and
a filter element received within and removably coupled to the shell housing, the filter element comprising an endplate including an annular sealing member extending axially away from the endplate and configured to extend into the housing groove.

12. The filter cartridge of claim 11, wherein the annular sealing member is configured to expand when positioned within the housing groove such that the annular sealing member forms a sealing engagement with both the first groove wall and the second groove wall.

13. The filter cartridge of claim 12, wherein the annular sealing member extends from the endplate a second height, the second height being greater than the first height.

14. The filter cartridge of claim 12, wherein the annular sealing member includes a bellows member that facilitates radial expansion of the annular sealing member to form the sealing engagement when the annular sealing member extends into the housing groove.

15. An endplate of a fluid filtration system, the endplate comprising:
a first sidewall defining at least a part of an outlet aperture;
a second sidewall disposed apart from the first sidewall;
a bottom surface extending between the first sidewall and the second sidewall; and
a coupling aperture extending through the endplate, the coupling aperture to receive a portion of a sealing member.

16. The endplate of claim 15, further comprising a plurality of coupling apertures including the coupling aperture, the plurality of coupling apertures disposed circumferentially around the outlet aperture, the plurality of coupling apertures corresponding to a plurality of coupling posts of the sealing member.

17. The endplate of claim 15, further comprising a plurality of ribs extending around the outlet aperture, the plurality of ribs comprising a first rib and a second rib, the first rib and the second rib comprising a plurality of rib segments separated by a plurality of gaps, wherein the first rib comprises a first gap and the second rib comprises a second gap, the first gap offset from the second gap.

18. The endplate of claim 15, further comprising:
a plurality of ribs extending from the bottom surface; and
a coupling groove disposed between an inner most rib and the first sidewall, the coupling aperture disposed within the coupling groove.

19. The endplate of claim 18, wherein the coupling groove comprises a first end and a second end, the first end defined by the bottom surface, the first end being larger than the second end, the second end configured to align with an end of the portion of the sealing member.

20. The endplate of claim 15, wherein the sealing member comprises:
a first rigid portion extending at least partially into the coupling aperture of the endplate;
a second rigid portion coupled to an end of the sealing member opposite the endplate; and
a compliant portion interposed between and coupled to both the first rigid portion and the second rigid portion,
wherein the first rigid portion comprises a coupling post that corresponds with the coupling aperture, the coupling post being substantially T-shaped with a top and a base, the top extending over the coupling aperture and the base extending into the coupling aperture.
